(19) United States
(12) Patent Application Publication
(10) Pub. No.: US 2023/0351421 A1
(43) Pub. Date: Nov. 2, 2023

(54) CUSTOMER-INTELLIGENCE PREDICTIVE MODEL

(71) Applicant: involve.ai, Inc., Santa Monica, CA (US)

(72) Inventors: Saumya BHATNAGAR, Los Angeles, CA (US); Hardika NARULA, San Jose, CA (US); Ella E. LUCAS, San Diego, CA (US); Gaurav BHATTACHARYA, Los Angeles, CA (US)

(21) Appl. No.: 18/306,358

(22) Filed: Apr. 25, 2023

Related U.S. Application Data
(60) Provisional application No. 63/336,961, filed on Apr. 29, 2022.

(51) Int. Cl. G06Q 30/0202

(52) U.S. Cl. CPC G06Q 30/0202

(57) ABSTRACT

In one embodiment, a method may access, from one or more data sources associated with a user, customer data associated with a customer of the user, wherein the customer data includes qualitative and quantitative data. The method can generate a plurality of normalized key performance indicators (KPIs) using the customer data and a normalization algorithm. The method can access a customer-health score model, wherein the customer-health score model is trained to determine a customer-health score using the plurality of normalized KPIs. The method can determine, using the customer-health score model, a customer-health score for the customer using the plurality of normalized KPIs. The method can send instructions for presenting a user interface to the user, the user interface comprising information associated with the plurality of normalized KPIs and the customer-health score for the customer.

### PRIORITY

This application claims the benefit under 35 U.S.C. § 119(e) of U.S. Provisional Patent Application No. 63/336,961, filed 29 Apr. 2022, which is incorporated herein by reference.

### TECHNICAL FIELD

This disclosure generally relates to customer intelligence.

### BACKGROUND

Customer retention is a crucial practice of increasing repeat customer rate for businesses and extracting additional values from customers. The goal of customer retention is to provide a mechanism to make a customer satisfied with services and goods from a company so that the customer tends to repeat purchases and the businesses do not defect to a competitor. Therefore, high customer retention is critical to a business' survival for the company. It is very desired to dynamically monitor and maintain high customer retention so that customers tend to return to, continue to purchase or in some other way not defect to another product or business, or to non-use entirely. The cost to acquire a new customer can be five to twenty-five times more than retaining an existing customer. By keeping and expanding the company's current customers, the company may reduce its customer-acquisition cost, increase its profitability, and improve its long-term business health.

Furthermore, customer intelligence facilitates a company's customer retention ability to turn customers into repeat buyers and prevent them from switching to a competitor. However, customer intelligence for effective customer retention at scale requires the collection, unification, and complex analysis of vast amounts of disparate and dispersed quantitative and qualitative data. It also requires intuitive presentation of complex information to users who need to understand the data to gain actionable insights into customer experience and customer needs. The ability of customer intelligence to attract and retain new customers is an important factor of a business model for the company, which is related not only to products or services, but also greatly enhance the value the customers actually create within and across the marketplace.

### SUMMARY OF PARTICULAR EMBODIMENTS

Particular embodiments described herein relate to systems and methods of using a customer-intelligence system to help a user (and the business that the user is associated with) better understand and retain customers through more accurate predictions of which customers are most at risk for cancellation, leading them into more targeted intervention strategies. The customer-intelligence system described herein is designed to support different users or companies that have different or heterogeneous data. For example, User A of the customer-intelligence system may be a mobile app company that tracks its app users' click rate, duration of app use, ratings given, in-app purchases, etc. User B of the customer-intelligence system may be a SaaS provider that provide cloud-based services to corporations. User B may track its customer's requests for support, severity of support, sentiment about the SaaS service, etc. Since every company/business has its own unique customer base and metrics, it a non-trivial challenge for a customer-intelligence system to be able to accommodate a wide variety of companies/businesses. The customer-intelligence system described herein provides a robust platform that could adapt to individual companies/businesses and their metrics and provide an intuitive interface with actionable intel for growing and retaining customers.

The customer-intelligence system can assess customer data from a customer from a client server. The customer data can include qualitative and quantitative information associated with the customer. The customer-intelligence system can use a machine learning model to determine a plurality of normalized key performance indicators (KPIs) using the customer data and a normalization algorithm. The customer-intelligence system can assess a customer health score model which is trained using a linear regression function to determine a customer-health score using the plurality of normalized KPIs. The customer-intelligence system can use the customer health score model to determine a customer-health score for the customer using the using the plurality of normalized KPIs. The customer-intelligence system can send to the client server instructions for presenting a user interface comprising the plurality of normalized KPIs and the customer-health score for the customer. By combining customer data with machine-learning algorithms, particular embodiments enable businesses to more accurately predict when a customer may be about to leave or be ready for upselling. Particular embodiments may also provide more valuable insights into what types of intervention tactics may work better for a particular customer and particular case. Particular embodiments may help businesses become proactive, action-oriented, and data-driven post-sales organizations, as opposed to more gut-based and reactive firehouses.

Particular embodiments provide a single platform where a user (and the business associated with the user) may obtain a deeper understanding of where money is being spent and on what fronts. Particular embodiments may also give the user (and the business associated with the user) more control over customer experience from on-boarding to renewals, while also identifying opportunities for increased revenue by identifying areas ripe with profit early during the customer relationship.

Particular embodiments may help a business entity to see the big picture of its customer accounts and growth opportunities. In particular embodiments, a user may receive insights on customer accounts and products so the user may focus on planning growth strategies while customer owners (or customer-success managers (CSMs)) focus on fighting churn and turning at-risk customers into more loyal customers. Particular embodiments handle tedious, manual back-end tasks to reduce time requirements associated with those tasks and to help generate more accurate, reliable insights. Particular embodiments capture and analyze both quantitative and qualitative information to obtain more accurate predictions and develop more accurate customer profiles. Particular embodiments provide prescriptive insights and predictions facilitating progress toward a business's growth goals.

Particular embodiments facilitate customer intelligence by automatically collecting, unifying, and carrying out complex analyses of vast amounts of disparate and dispersed quantitative and qualitative customer data for users. Particular embodiments provide intuitive presentation of complex information to users who need to understand the data to gain actionable insights into customer experience and customer needs.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment with an example customer-intelligence system.

FIG. 2 illustrates an example customer-intelligence system.

FIG. 3 illustrates an example customer-intelligence dashboard.

FIG. 4 illustrates an example detailed view of a portion of an example customer-intelligence dashboard.

FIG. 5 illustrates example weighting of example key performance indicators (KPIs) in example customer-health score generation.

FIG. 6 illustrates example feature enablement in an example customer-health score.

FIG. 7 illustrates an example Elbow-method graph.

FIGS. 8A-8C illustrates an example presentation of example general information on a customer in an example customer-intelligence dashboard.

FIGS. 9A-9B illustrates example presentation of example key indicators for a customer.

FIG. 10 illustrates example presentation of example customer history for an example customer on an example customer-intelligence dashboard.

FIG. 11 illustrates example presentation of example tracked contacts for an example customer on an example customer-intelligence dashboard.

FIG. 12 illustrates example presentation of example information cards on an example customer on an example customer-intelligence dashboard 302.

FIG. 13 illustrates an example window for example prediction feedback on an example customer-intelligence dashboard 302.

FIG. 14 illustrates example presentation of KPIs and their contributions to a customer-health score.

FIG. 15A illustrates an example method for providing a customer-intelligence dashboard.

FIG. 15B illustrates an example method for determining customer-health score.

FIG. 16 illustrates example window 1600 simple view of high, medium, and low scores presented for the KPIs and health scores using a seven-feature model.

FIG. 17 illustrates example window 1700 simple view of normalized KPIs and health scores using a nine-feature model.

FIG. 18 illustrates example window 1800 simple view of key indicators normalized with respect to a customer.

FIG. 19 illustrates example neural network 1900 for determining a customer-health score 1922 using normalized KPIs 1920.

FIGS. 20A and 20B illustrate example inference or prediction processes with high and low customer-health scores.

FIGS. 21A and 21B illustrate example impact of SHAP analysis on the output of the AI model.

FIG. 22 illustrates an example computer system 2200.

### DESCRIPTION OF EXAMPLE EMBODIMENTS

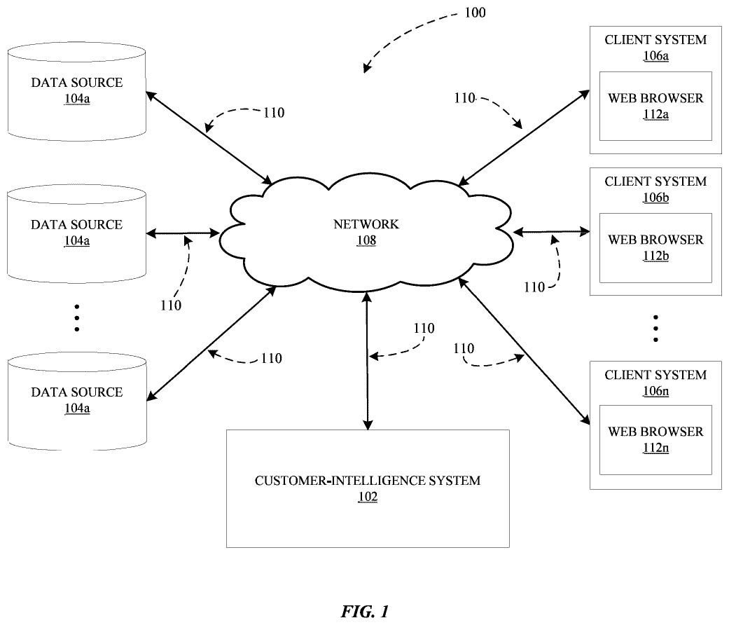

FIG. 1 illustrates an example network environment 100 with an example customer-intelligence system 102. In the example of FIG. 1, network environment 100 includes customer-intelligence system 102, data sources 104, and client systems 106 connected to each other by a network 108. Although FIG. 1 illustrates a particular arrangement of customer-intelligence system 102, data sources 104, client systems 106, and network 108, this disclosure contemplates any suitable arrangement of customer-intelligence system 102, data sources 104, client systems 106, and network 108. As an example and not by way of limitation, customer-intelligence system 102 may be connected to one or more data sources 104 directly, bypassing network 108. As another example, customer-intelligence system 102 may be connected to one or more client systems 106 directly, bypassing network 108. As another example, two or more data sources 104 may be connected to each other directly, bypassing network 108. As another example, two or more client systems 106 may be connected to each other directly, bypassing network 108. As another example, customer-intelligence system 102 may be physically or logically co-located with one or more data sources 104. As another example, customer-intelligence system 102 may be physically or logically co-located with one or more client systems 106. As another example, one or more data sources 104 may be physically or logically co-located with one or more client systems 106. As another example, two or more data sources 104 may be physically or logically co-located with each other. As another example, two or more client systems 106 may be physically or logically co-located with each other. Moreover, although FIG. 1 illustrates a particular number of customer-intelligence systems 102, data sources 104, client systems 106, and networks 108, this disclosure contemplates any suitable number of customer-intelligence systems 102, data sources 104, client systems 106, and networks 108. As an example and not by way of limitation, network environment 100 may include multiple customer-intelligence systems 102 and multiple networks 108.

This disclosure contemplates any suitable network 108. As an example and not by way of limitation, one or more portions of network 108 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 108 may include one or more networks 108.

Links 110 may connect customer-intelligence system 102, data sources 104, and client systems 106 to network 108 or to each other. This disclosure contemplates any suitable links 110. In particular embodiments, one or more links 110 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 110 each include an ad hoc network, an intranet, an extranet, a VPN, a LAN, a WLAN, a WAN, a WWAN, a MAN, a portion of the Internet, a portion of the PSTN, a cellular-technology-based network, a satellite-communications-technology-based network, another link 110, or a combination of two or more such links 110. Links 110 need not necessarily be the same throughout network environment 100. One or more first links 110 may differ in one or more respects from one or more second links 110.

In particular embodiments, a client system 106 may be an electronic device including one or more hardware, software, or embedded logic components or a combination of two or more such components capable of carrying out functions implemented or supported by client system 106. As an example and not by way of limitation, a client system 106 may include a computer system such as a desktop computer, notebook or laptop computer, netbook, a tablet computer, mobile telephone, augmented-reality (AR) or virtual-reality (VR) device, other suitable electronic device, or any suitable combination thereof. This disclosure contemplates any suitable client systems 106. A client system 106 may enable a user at client system 106 to access network 110 and communicate with customer-intelligence system 102. As an example and not by way of limitation, a client system 106 may be associated with a business entity (which many be an individual or a company) and a user at client system 106 may access customer-intelligence system 102 using a web browser 112 at client system 106 and interact with one or more web-based applications hosted by customer-intelligence system 102 (such as, for example, customer-intelligence dashboard 302 described below) to gain actionable insights into customer experience and customer needs to proactively drive customer retention by the business entity. Herein, reference to a user may encompass the business entity that the user is associated with, and vice versa, where appropriate. Herein, reference to a business may encompass a business entity, and vice versa, where appropriate. Herein, reference to a client may encompass a user at a client system 106 or a business entity that the user is associated with, and vice versa, where appropriate. Client systems 106 need not necessarily be the same throughout network environment 100. One or more first client systems 106 may differ in one or more respects from one or more second client systems 106.

In particular embodiments, a client system 106 may include a web browser 112, such as MICROSOFT EDGE, GOOGLE CHROME, MOZILLA FIREFOX, or APPLE SAFARI, and web browser 112 may have one or more add-ons, plug-ins, or other extensions. A user at a client system 106 may enter a Uniform Resource Locator (URL) or other address directing web browser 112 at client system 106 to a particular server (such as a server associated with customer-intelligence system 102), and web browser 112 may generate a Hyper Text Transfer Protocol (HTTP) request and communicate the HTTP request to that server. The server may accept the HTTP request and communicate to client system 106 one or more Hyper Text Markup Language (HTML) files responsive to the HTTP request. Client system 106 may render a webpage based on the HTML files from the server for presentation to the user. This disclosure contemplates any suitable webpage or other source files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage or other source files (which a web browser 112 may use to render the webpage) and vice versa, where appropriate.

Data sources 104 may store various types of information. In particular embodiments, the information stored in a data source 104 may be organized according to specific data structures. In particular embodiments, one or more data sources 104 may each be a relational, columnar, correlation, or other suitable database. Although this disclosure describes particular types of databases, this disclosure contemplates any suitable types of databases. In particular embodiments, a data source 104 may include one or more interfaces that enable customer-intelligence system 102 or one or more client systems 106 to manage, retrieve, modify, add, or delete information stored in data source 104. Data sources 104 may be customer-relationship management (CRM) platforms or other sources of customer data, such as, for example, SALESFORCE, CHURNZERO, SNOWFLAKE, JIRA, ZENDESK, GMAIL, MICROSOFT OUTLOOK, SLACK, ZOOM or any other suitable CRM platform or other source of customer data. Data sources 104 need not necessarily be the same throughout network environment 100. One or more first data sources 104 may differ in one or more respects from one or more second data sources 104.

The customer data in data sources 104 may be dispersed and disparate and may be quantitative or qualitative. Examples of dispersed qualitative data include e-mail, call notes, and chat records. Customer data stored in data sources 104 may include product-usage, support, and communication signals and other suitable customer data. As an example and not by way of limitation, as between a particular business and a particular customer of that business, customer data may include one or more of the following, in any suitable combination: support tickets for the customer; assessments of the business's relationship with the customer (or “customer health”) by the business's customer owner (or CSM) for the customer; e-mails between the business and customer; notes about the customer by the business's customer owner (or CSM) for the customer; transcriptions of telephone calls between the business and customer; intercom chats between the business and customer; text messages between the business and customer; notes about telephone calls between the business and customer; net promoter score (NPS) or customer satisfaction (CSAT) comments; written interaction between the business and customer; relevant logins by the customer; relevant sessions by the customer; relevant session times for the customer; relevant API calls by the customer; relevant API throttle limits for the customer; relevant API usage cyclicity by the customer; relevant report downloads by the customer; relevant page views by the customer; transactions between the business and customer; billable actions by the business for the customer; non-billable actions by the business for the customer; value-added actions by the business for the customer; relevant product add-ons requested by the customer; relevant time on product by the customer; relevant quote-to-order conversion for the customer; invoices generated by the business for the customer; order volume for the customer; a maturity level of the customer with respect to the business; identification of the business's customer owner (or CSM) for the customer; relevant revenue (e.g. annual recurring revenue (ARR)) attributable to the customer; relevant renewal dates for the customer with respect to the business. Although particular customer data in particular data sources is described and illustrated, this disclosure contemplates any suitable customer data in any suitable data sources. Herein, reference to a product provided by a business may encompass a service provided by the business, and vice versa, where appropriate.

Customer-intelligence system 102 may be a network-addressable computing system that can host an online customer-intelligence platform providing one or more customer-intelligence web-based applications. Customer-intelligence system 102 may integrate with data sources 104 and, through those integrations, access customer data stored at data sources 104. Customer-intelligence system 102 may analyze the customer data and, based on the analysis, generate predictions about customer churn and opportunities for expanding revenue and identify tasks to improve overall customer experience. Customer-intelligence system 102 may organize that information for presentation to users at client systems 106, who may then act on that information.

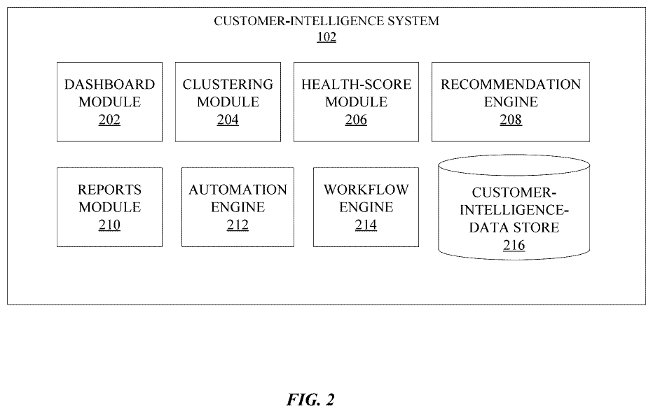

FIG. 2 illustrates an example customer-intelligence system 102. In the example of FIG. 2, customer-intelligence system 102 includes a dashboard module 202, clustering module 204, health-score module 206, recommendation engine 208, reports module 210, automation engine 212, workflow engine 214, and customer-intelligence-data store 216. In particular embodiments, dashboard module 202, clustering module 204, health-score module 206, recommendation engine 208, reports module 210, automation engine 212, workflow engine 214, and customer-intelligence-data store 216 are hardware, software, or embedded logic components or a combination of two or more such components capable of carrying out particular functions of customer-intelligence system 102. In particular embodiments, the information stored in customer-intelligence-data store 216 may be organized according to specific data structures, such as, for example, a relational, columnar, correlation, or other suitable database. Although customer-intelligence system 102 is described and illustrated as including particular components in a particular arrangement, this disclosure contemplates customer-intelligence system 102 including any suitable components in any suitable arrangement. As an example and not by way of limitation, customer-intelligence system 102 may include one or more of each of dashboard module 202, clustering module 204, health-score module 206, recommendation engine 208, reports module 210, automation engine 212, workflow engine 214, and customer-intelligence-data store 216. As another example, one or more of each of dashboard module 202, clustering module 204, health-score module 206, recommendation engine 208, reports module 210, automation engine 212, workflow engine 214, and customer-intelligence-data store 216 may be physically or logically co-located with each other in whole or in part or share one or more hardware, software, or embedded-logic components with each other.

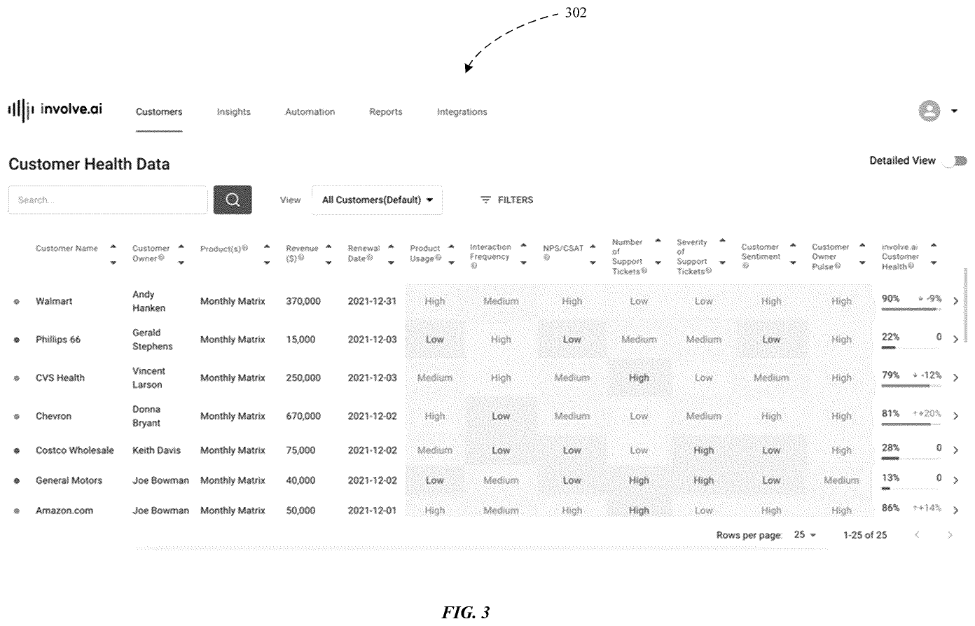

In particular embodiments, as described more fully below, dashboard module 202 generates for presentation to a client a customer-intelligence dashboard (an example of which is illustrated as customer-intelligence dashboard 302 in FIGS. 3-13) that unifies customer data and generates predictions about the client's customer churn, customer renewal, or customer upsell; clustering module 204 segments customer data into component parts by analyzing similarities among the feature space; health-score module 206 generates customer-health scores for presentation to users in customer intelligence dashboard 302; recommendation engine 208 uses information from dashboard 302 to generate actionable recommendations based on data changes on dashboard 302; reports module 210 uses the dashboard to generate high-level reporting data summarizing customer revenue and churns and upsells, along with trends around the KPIs; automation engine 212 enables users to create automation rules to update static data and values on dashboard 302; workflow engine 214 enables a user to create communication workflows based on data-value changes on dashboard 302; and customer-intelligence-data store 216 stores customer data processed by customer-intelligence system 102 and other information generated by customer-intelligence system 102.

In particular embodiments, customer-intelligence dashboard 302 is an artificial intelligence (AI)-driven early-warning dashboard that helps businesses reduce churn and accelerate revenue growth, unlocking predictive customer intelligence from existing customer data. More information on the use of AI in customer intelligence may be found in U.S. patent application Ser. No. 17/515,314, filed 29 Oct. 2021 and entitled Named Entity Recognition System for Sentiment Labeling, which is incorporated herein by reference in its entirety. In particular embodiments, AI automatically picks up on trends and patterns as the business gains more customers. The more data and feedback the AI receives, the better its predictions become. In particular embodiments, the customer-intelligence dashboard unifies KPIs for customer experience from product usage, support, and communication signals from data sources 104. These signals then go through particular algorithms to predict top churn risks, revenue expansion opportunities, and tasks to improve overall customer experience.

In particular embodiments, customer-intelligence dashboard 302 is intuitive, automated, actionable, and AI-driven and facilitates the automatic capture and analysis of customer data for insights to predict potential customer issues and better understand customer-growth potential. In particular embodiments, to generate these predictions, customer-intelligence system 102 integrates with over 176 data sources 104 used by clients. Through these integrations, customer-intelligence system 102 receives access to customer data in data sources 104. While this data may vary depending on the business model, particular embodiments assess and analyze particular categories and KPIs to create more comprehensive customer profiles and provide more accurate churn prediction. In particular embodiments, one or more of the following categories are assessed and analyzed: customer name; customer owner (or CSM); product(s); revenue (e.g. annual recurring revenue (ARR)); or renewal date. In particular embodiments, one or more of the following KPIs are assessed and analyzed: product usage (which may be the frequency at which the customer uses or purchase the product(s)); interaction frequency (which may be the frequency of interaction between the customer and the business and may be measured in e-mail, telephone calls, and visits); NPS/CSAT (which may be the level of customer satisfaction); number of support tickets (which may be the number of support requests submitted by the customer); severity of support tickets (which may be the severity of the issues in the support tickets); customer sentiment (which may be an analysis of written interaction between the business and customer); customer-owner pulse (which may be an assessments of the business's relationship with the customer (or “customer health”) by the business's customer owner (or customer-success manager (CSM) for the customer); up-sells/down-sells (which may be an increase or decrease in revenue generated from the customer); or customer maturity (which may be where the customer is in a customer lifecycle with respect to the business). Although particular categories and particular KPIs are described and illustrated, this disclosure contemplates any suitable categories and any suitable particular KPIs.

In particular embodiments, product usage by a customer may be determined from one or more of the following in any suitable combination: logins, sessions, session times, number of users timeframe, number of API calls, APR throttle limits, API usage cyclicity, report downloads, page views, number of transactions processed, dollar value of transactions processed, billable actions versus non-billable actions, number of value-added actions, number of product add-ons, time on product, quote-to-order conversion, generated invoices, or order volume. In particular embodiments, interaction frequency may be determined from one or more of the following: e-mails, CSM notes, support-ticket descriptions, transcriptions of telephone calls, intercom chats, text messages, telephone calls, telephone-call notes, or NPS or CSAT comments. Although particular KPIs are described as being determined from particular customer data, this disclosure contemplates any suitable KPIs being determined from any suitable customer data.

In particular embodiments, each KPI measures a different aspect of a customer. As an example and not by way of limitation, product usage may indicate how often the customer is using a particular product, which may indicate how important that product is to the customer. As another example, interaction frequency between the customer and the business (whether e-mails, calls, or visits) may indicate the customer's commitment or loyalty to the business. However, interaction frequency alone may be insufficient to fully indicate the customer's commitment or loyalty to the business. The content of those interactions (what the customer writes or says in those e-mails, calls, and visits) is important. This is represented by renewal sentiment. When dealing with such complex customer data, particular embodiments use AI to calculate the business's unique KPIs and automatically compares them to industry best practices, which results in more suitable or reasonable value for the business's unique situations.

FIG. 3 illustrates an example customer-intelligence dashboard 302. Customer-intelligence dashboard 302 may be generated by dashboard module 202 working with one or more other components of customer-intelligence system 102 in response to a request from a user at a client system 106. In the example of FIG. 3, intelligence dashboard 302, as generated for the user, includes information for the following customers, which may be customers of the business entity that the user is associated with: WALMART, PHILLIPS 66, CVS HEALTH, CHEVRON, COSTCO WHOLESALE, GENERAL MOTORS, and AMAZON. For each customer, the following categories are presented: (1) customer name; (2) customer owner (or CSM); (3) product(s); (4) revenue; and (5) renewal date. The following KPIs are also presented: (1) product usage; (2) interaction frequency; (3) NPS/CSAT; (4) number of support tickets; (5) severity of support tickets; (6) customer sentiment; and (7) customer-owner pulse. Additional KPIs that could be presented, but are not shown in FIG. 3, include (8) up-sells/down-sells and (9) customer maturity. Although customer-intelligence dashboard 302 is described and illustrated as presenting particular information in a particular arrangement, this disclosure contemplates customer-intelligence dashboard 302 presenting any suitable information in any suitable arrangement.

Particular embodiments set a threshold value (e.g. high, medium, or low) for customer health. In particular embodiments, these values are benchmarked across multiple businesses per product per ARR range per quarter. This metric may indicate to a user when and what action should be taken (e.g. whether to prevent churn for a customer with a low health score or capture an upsell opportunity for a customer with a high health score). For each KPI for each customer, customer-intelligence dashboard 302 presents a color-coded score of low, medium, or high. With some KPIs, a low score is considered positive and a high score is considered negative. With other KPIs, a high score is considered positive and a low score is considered negative. A KPI score of medium may be considered neutral. A positive KPI score may be color coded green, a negative KPI score may be color coded red, and a neutral KPI score may be color coded yellow. In the example of FIG. 3, high product usage is considered positive, medium product usage is considered neutral, low product usage is considered negative, high interaction frequency is considered positive, medium interaction frequency is considered neutral, low interaction frequency is considered negative, high NPS/CSAT is considered positive, medium NPS/CSAT is considered neutral, low NPS/CSAT is considered negative, high customer sentiment is considered positive, medium customer sentiment is considered neutral, low customer sentiment is considered negative, high customer-owner pulse is considered positive, medium customer-owner pulse is considered neutral, low customer-owner pulse is considered negative, low number of support tickets is considered positive, medium number of support tickets is considered neutral, high number of support tickets is considered negative, low severity of support tickets is considered positive, medium severity of support tickets is considered neutral, and high severity of support tickets is considered negative. These KPI scores may be color coded accordingly in customer-intelligence dashboard 302. This color coding may facilitate a user more quickly understanding which customer relationships are strong (and thus present up-sell opportunities), which are weak (and thus at risk for churn), and, more particularly, in each group, what aspects of those relationships are contributing positively or negatively to their overall status.

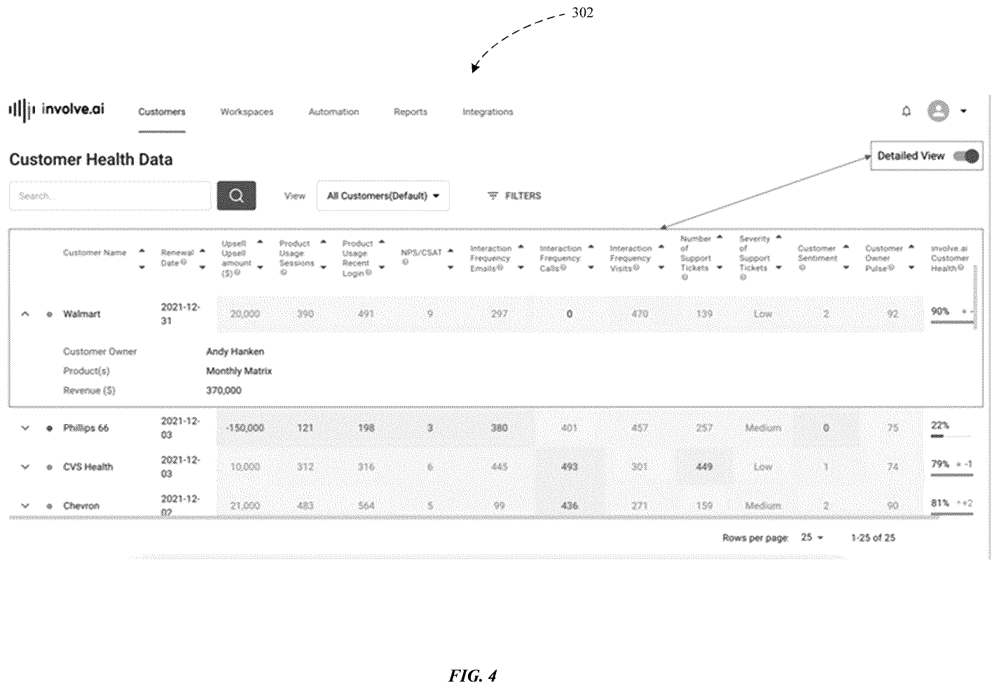

FIG. 4 illustrates an example detailed view of a portion of customer-intelligence dashboard 302, where the numerical values for those scores or other detailed summaries are presented, enabling the user to obtain more detail on those KPIs. Each KPI may be broken down into an individual metric contributing to the customer's health score. As an example and not by way of limitation, product usage may include login information, number of sessions, etc. As another example, interaction frequency may be divided into e-mails, telephone calls, and visits. This may enable a user to view a clearer demarcation of the health-score values, how they contribute to the threshold established, and which metrics should change to improve that score.

Returning to FIG. 3, customer-intelligence dashboard 302 also presents a customer-health score (shown on the right side of customer-intelligence dashboard 302) for each customer, along with a change (positive or negative) since a last health score. In particular embodiments, a health score for a customer indicates a likelihood that the customer will churn, renew, or upsell. Generally, the higher the health score, the stronger the relationship with the customer and the greater the possibility of up-selling the customer. Similarly, the lower the health score, the weaker the relationship with the customer and the greater the possibility of churn. Generally, the more neutral the health score, the more neutral the relationship with the customer and the greater the possibility of the customer renewing without up-selling. In particular embodiments, a customer with a health score that has fallen below a threshold value may represent a high probability of churn. The business may want to take preventative measures with that customer before churn occurs. A higher customer-health score may indicate that the customer has been using the business's product(s) frequently and is satisfied and turning into a loyal customer. A loyal customer may be a good candidate for upsell or cross-sell by the business.

In particular embodiments, to generate a customer-health score, customer-intelligence system 102 may use clustering module 204 to segment customer data into component parts associated with a plurality of normalized KPIs by analyzing similarities among the feature space. Herein, reference to a feature may encompass a KPI, and vice versa, where appropriate. This may provide users with a deeper understanding of the data-normalization-and-inference process without requiring users to be well versed in machine learning (ML) or statistics. Particular embodiments provide a renewal probability score for each customer based on a seven-feature or nine-feature model. In particular embodiments, clustering module 204 uses SHapley Additive exPlanations (SHAP) via Shapley values to represent feature weightages. Clustering module 204 may also incorporate segmentation using a K-means clustering algorithm with Elbow method to determine K. Clustering module 204 may also review which of all possible features are available for a particular business. In particular embodiments, use of clustering module 204 in customer-intelligence system 102 facilitates scaling the clustering and benchmarking process and clustering module 204 provides deep context on the feature space to help users contextualize the renewal probability outputs and understand customer segmentation in a comprehensive user interface (UI).

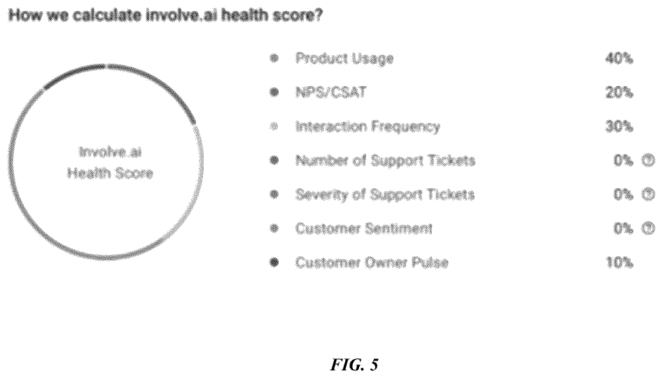

FIG. 5 illustrates example KPI weighting in example customer-health score generation. Particular embodiments combine feature existence, weightage analysis, clustering, and benchmarking in a comprehensive UI for customer-health-score understanding and validation. In the example of FIG. 5, four KPIs are used to generate a customer-health score (product usage, NPS/CSAT, interaction frequency, and customer-owner pulse), with other KPIs being unavailable and weighted at zero. In particular embodiments, dynamic-clustering component parts are available on customer-intelligence dashboard 302. The data will be refreshed on a weekly basis, generating new segments, existence analysis, and feature weightages to be displayed in the Clustering tab of the product.

Particular embodiments facilitate better understanding of the relevance of each KPI and provide information describing the relative weightage of each KPI based on SHAP. The KPIs may be color coded and are represented in a pie chart. The outcome is a visual representation of the relative weightages of each feature component of the health-score algorithm executed by health-score module 206. In particular embodiments, the health-score model takes normalized numeric X={0, 1, 2} features and returns the numeric prediction Y={0, . . . ,99}. In particular embodiments, the health-score model can implement a four step process to determine the high, medium, and low values by achieving the 0, 1, or 2 normalized values over the KPIs: 1) import the widely used “pandas” library, 2) apply normalization to the values over the KPIs, 3) calculate the mean of each row in the values with multiple components over the KPIs, and 4) convert values to whole numbers. In particular embodiments, the health-score model can import a library, such as the “pandas” library, from a public source during the first step. In particular embodiments, the health-score model can implement a min/mean normalization method which may be applied across all input columns during the second step. In particular embodiments, the min and mean values come from the column that corresponds to the individual metric from the client's raw data. For example, if there is a column corresponding to Interaction Frequency: Emails with values [5, 7, 3, 11], then the normalize ( ) function receives the column, 3, and 11 as inputs and returns the 0, 1, or 2 normalized values for each row. If there is a metric with several components (say Interaction Frequency includes both Emails and Calls) then each component metric is individually normalized according to the above definition. Next, the mean of each row may be computed for the component metrics. In particular embodiments, the health-score model can implement a common mathematical normalization which may be applied across all input columns during the second step. The health-score model can determine a low or “0” value when input data is in the 1^{st} quantile, a medium or “1” value when input data is in the 2^{nd} or 3^{rd} quantile, and a high or “2” value when input data is in the 4^{th} quantile. In particular embodiments, the health-score model can take df[‘product_usage_’] pass the ‘product_usage_’ column during the third step and convert those values back to whole numbers 0, 1, or 2 during the fourth step as taking the average of the rows may have resulted in decimal As a result, the health-score model can determine the high, medium, and low values, which are used as filtering criteria when computing the benchmarks per cluster. An example of achieving the 0, 1, or 2 normalized values over the KPIs for the high, medium, and low values can be found in Table 1.

TABLE 1
An example of achieving the high, medium, and low values over the KPIs

| | Step Description | Example |
|---|---|---|
| 1 | import the widely | import pandas as pd |
| | used “pandas” | |
| | library | |
| 2 | Apply normalization | def normalize (data, min, mean): |
| | to the values over | if pd.isna(data) |
| | the KPIs | return data, ‘Does not Exist’ |
| | | norm = 2.*(data − min)/(mean − min) − 1 |
| | | if norm < −0.4: |
| | | return 0, ‘Low’ |
| | | if norm > 0.3: |
| | | return 2, ‘High’ |
| | | if norm >= −0.4 and norm <= 0.3: |
| | | return 1, ‘Medium’ |
| 3 | Calculate the mean | df[‘product_usage_’] = |
| | of each row in the | df[[‘product_usage_emails_’,‘product_usage_calls_’]].mean(axis=1) |
| | values with multiple | |
| | components over the | |
| | KPIs | |
| 4 | Convert values back | def normalize_II (data): |
| | to whole numbers | if pd.isna(data) |
| | | return data, ‘Does not Exist’ |
| | | if data >1: |
| | | return int (2), ‘High’ |
| | | elif norm < 1: |
| | | return int(0), ‘Low’ |
| | | else: return int(1), ‘Medium’ |

In particular embodiments, the percentages come from SHAP analysis on the back end, which takes the fitted LinearLearner as input and returns the SHAP value per feature. Clustering module 204 further decomposes the SHAP values from an abstract representation based on the difference between the baseline model output and the current model output for the prediction being explained to a float percentage. In particular embodiments, scaling the SHAP values to a percentage (e.g. as shown in Table 2 below) may help the user better understand which KPIs contribute the most to the health scores for their customer accounts, based on their unique customer data. An example of the percentages for scaling the SHAP values can be found in Table 2.

TABLE 2
An example of the percentages for scaling the SHAP values.

| Features | Importance | Percentage |
|---|---|---|
| Product_usage | 9.813389 | 0.436429 |
| Interaction_frequency | 5.137598 | 0.228484 |
| Severity_score | 4.896132 | 0.217745 |
| NPS/CSAT | 2.333693 | 0.103786 |
| Renewal_sentiment | 0.304825 | 0.013556 |
| Customer_pulse | 0 | 0 |

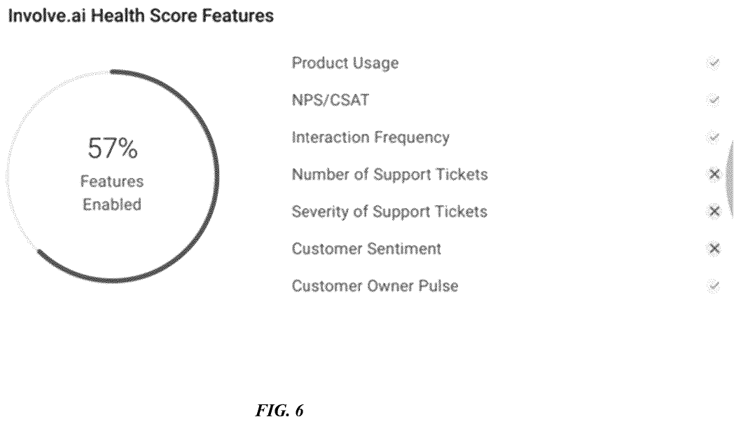

In particular embodiments, features represent the key elements that contribute to the customer's health score. Particular embodiments show the customer, the presence, and the contribution made by each KPI. Customer-intelligence system 102 checks the existence of these KPIs for a business and helps the user understand those KPIs better. In particular embodiments, the values are represented in Boolean (e.g. true if the feature exists and value exists in the client's customer data, else the features will be marked as false). This may help the business to understand what features exist in the database. As an example and not by way of limitation, the following KPIs may be used, in any suitable combination: (1) product usage, (2) interaction frequency, (3) NPS/CSAT, (4) number of support tickets, (5) severity of support tickets, (6) customer sentiment, (7) customer-owner pulse, (8) up-sells/down-sells, and (9) customer maturity. FIG. 6 illustrates example feature enablement in an example customer-health score, which may be presented to a user to help the user better understand the customer-health score being provided.

In particular embodiments, the K-Means clustering algorithm is used to generate customer-health scores. the K-Means clustering algorithm is an unsupervised ML algorithm that groups similar data points together and discovers underlying patterns. To achieve this, the K-Means clustering algorithm looks for a fixed number of K clusters in a dataset. Particular embodiments define the K-number of clusters for the customers data based on a result derived from the Elbow method. the K-Means clustering algorithm identifies K number of centroids and then allocates every data point to the nearest cluster, while keeping the centroids as small as possible. In particular embodiments, the K-Means clustering algorithm involves five steps: 1) select the number of clusters for the dataset (K), 2) select K number of centroids, 3) by calculating the Euclidean distance or Manhattan distance, assign the points to the nearest centroid, thus creating K groups, 4) find the original centroid in each group, and 5) again reassign the whole data point based on this new centroid, then repeat step four above until the position of the centroid does not change.

In particular embodiments, finding the optimal number of clusters is an important part of this algorithm. Particular embodiments use the Elbow method to find an optimal K value. The number of clusters is determined using the Elbow method, which involves running the algorithm multiple times over a loop on the client's customer data, with an increasing number of cluster choice and then plotting a clustering score as a function of the number of clusters.

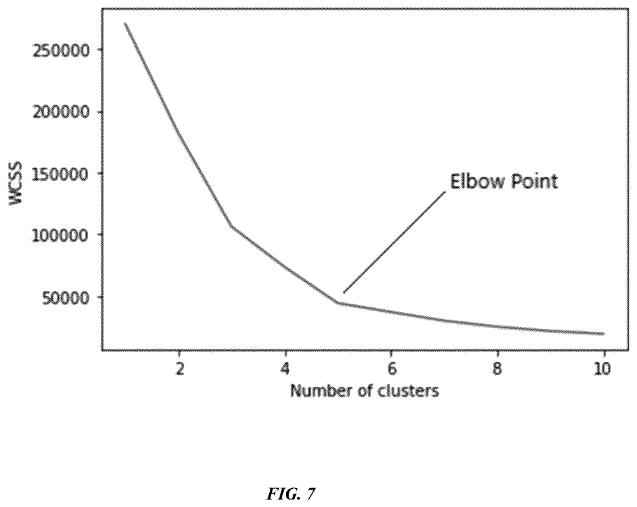

FIG. 7 illustrates an example Elbow-method graph. In particular embodiments, the Elbow method varies the number of clusters (K) from one to 10. For each value of K, Within-Cluster Sum of Square (WCSS) is calculated. WCSS is the sum of squared distance between each point and the centroid in a cluster. When the WCSS is plotted with the K value, the plot looks like an Elbow. As the example of FIG. 7. illustrates, the WCSS value starts to decrease as the number of clusters increases. WCSS value is largest when K=1. The graph will rapidly change at a particular point and thus create an elbow shape. From this point, the graph starts to move almost parallel to the X-axis. The K value corresponding to this point is the optimal K value or an optimal number of clusters. With the optimal K value from the Elbow method, particular embodiments then run the K means over the client's customer data to divide them into K groups. They are then saved separately to analyze each cluster based on the KPI values present.

In particular embodiments, after running the K-means clustering algorithm on the client's customer data and assigning the cluster values to each row, the customer data may then be separate and saved separately for further analysis. Particular embodiments iterate through each cluster and describe the key features for the client in each cluster, like customer count in each cluster, average revenue for each cluster, active versus churned users in each cluster, etc. The benchmarks for the KPIs are also calculated by evaluating the minimum and the maximum value for each category present. For example, a KPI will have “Low,” “Medium,” and “High” categories and the user will be able to see the minimum and maximum value in each category, which will help the user get an idea of how each KPI is contributing to the overall performance (or customer-health score). If a business has significantly lower values for any KPI on any cluster, then the business can focus on the customers that are present inside that cluster to find the similarities among that business's customers and strategize better.

In particular embodiments, after clustering module 204 has processed each component part of the customer data, the customer data is unified for deployment. In particular embodiments, the result is a JSON file. An example of items in a JSON file can be found in Table 3.

TABLE 3
An example of items in a JSON file.

| | Description |
|---|---|
| | Timestamp |
| | The deployment time (e.g. UTC) |
| | Name of metric (i.e.: product usage, interaction frequency, etc.) |
| Items | Value: SHAP value converted to a float percentage |
| Health Score | Available: Boolean value representing existence |
| Segments: Name | Name of the segment (e.g.: cluster 1, cluster 2, . . .) |
| Segments: | Number of customers per cluster |
| Description | Average revenue per customer per cluster |
| | Number of customers per cluster with an active subscription to the product |
| | or service |
| | Average amount of money active customers spend on the product or |
| | service |
| | Number of customers per cluster that terminated their subscription to the |
| | product or service |
| | Average amount of money churned customers spent on the product or |
| | service when they were active |
| | Active customers by name |
| | Churned customers by name |
| Benchmarks: | i.e.: product usage, interaction frequency, etc. |
| Name of metric | |
| Benchmarks: | Name of metric per KPI (i.e.: Interaction Frequency: E-mails, Interaction |
| Items | Frequency: Calls) |
| | High |
| | From: Minimum of the metric's raw values (e.g.: For this cluster, the |
| | smallest number of e-mails that may be exchanged for a company to |
| | still be considered to have overall high interaction frequency) |
| | To: Maximum of the metric's raw values (e.g.: For this cluster, this |
| | will be the highest number of e-mails exchanged across the dataset) |
| | Medium |
| | From: Minimum of the metric's raw values (e.g.: For this cluster, the |
| | smallest number of e-mails that may be exchanged for a company to |
| | still be considered to have overall medium interaction frequency) |
| | To: Maximum of the metric's raw values (e.g.: For this cluster, the |
| | largest number of e-mails that may be exchanged for a company to still |
| | be considered to have overall medium interaction frequency) |
| | Low |
| | From: Minimum of the metric's raw values (e.g.: For this cluster, this |
| | will be the lowest number of e-mails exchanged across the dataset) |
| | To: Maximum of the metric's raw values (e.g.: For this cluster, the |
| | largest number of e-mails that may be exchanged for a company to still |
| | be considered to have overall low interaction frequency) |

In particular embodiments, in the JSON file, there are x segments, depending on the number of clusters identified by the Elbow Method. Each segment is a nested dictionary with “name,” “description,” and “benchmarks” components. Within “Benchmarks,” wherever a given KPI does not contain component metrics, there will only be one associated column of raw data, so the “items” object is unnecessary. In that case, “Benchmarks” will contain “Column_id,” “High,” “Medium,” and “Low.” Also, within “Benchmarks,” “High” corresponds to the normalized numerical feature 2, “Medium” corresponds to the normalized numerical feature 1, and “Low” corresponds to the normalized numerical feature 0.

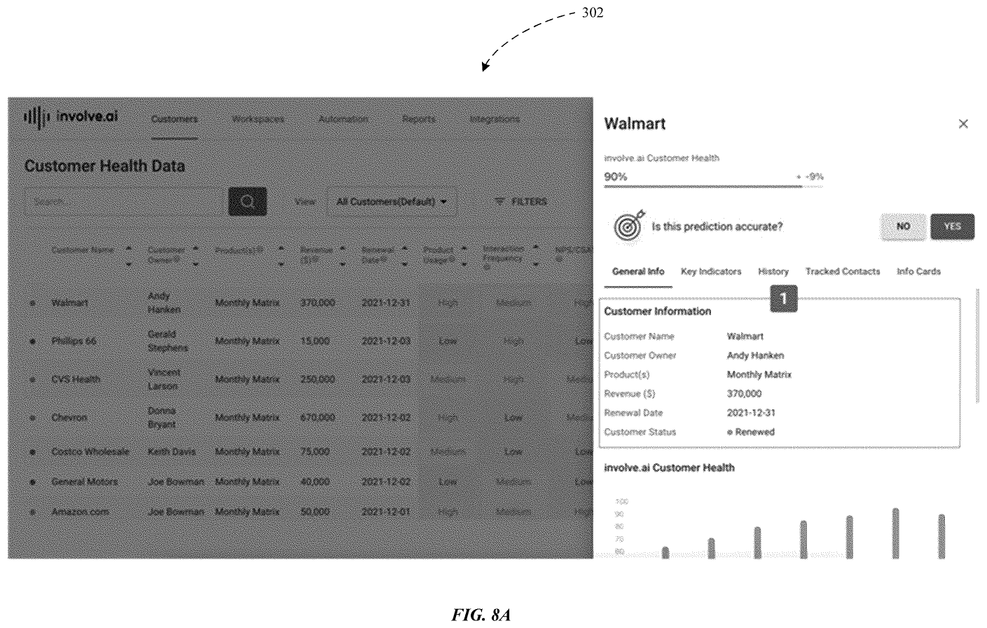

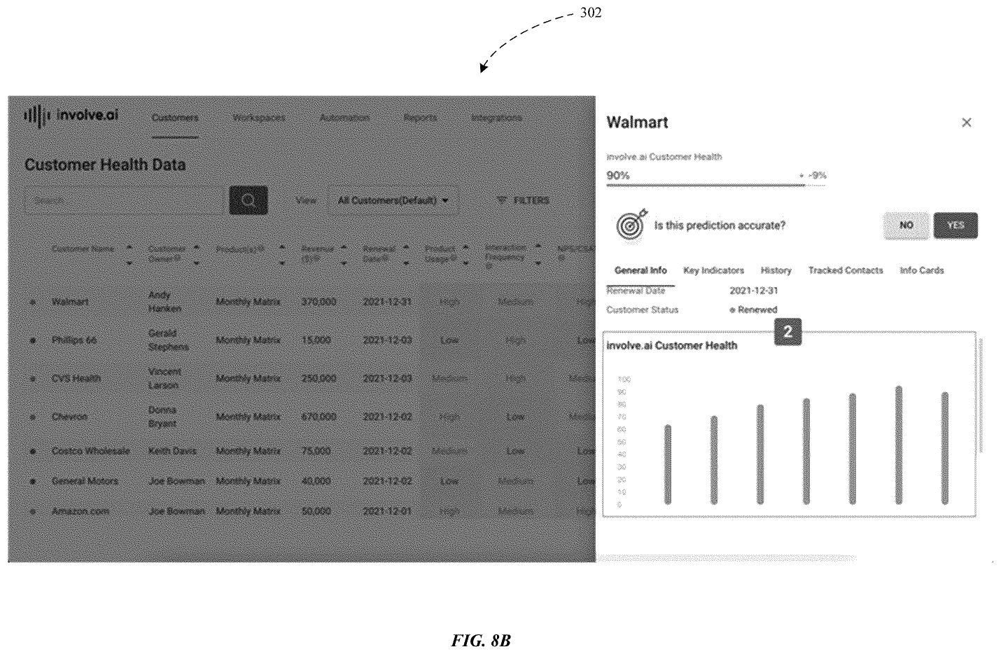

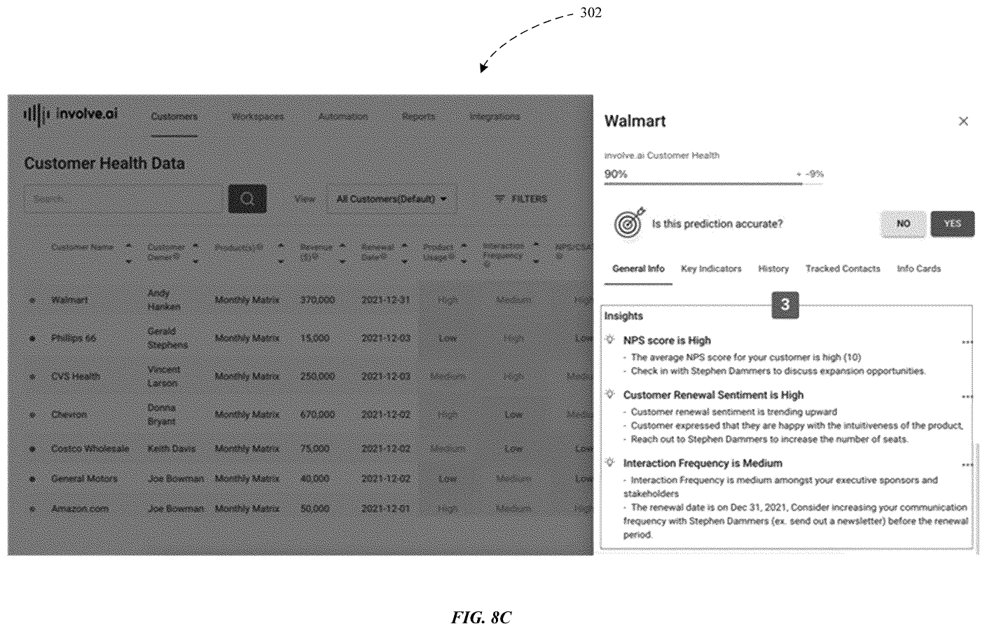

Returning to customer-intelligence dashboard 302, FIGS. 8A-8C illustrate example presentation of example general information on an example customer in an example customer-intelligence dashboard 302. In particular embodiments, general information for a customer may include high-level customer information, customer-health trend, and customer insights. The high-level customer information may include the following: customer name, customer-owner (or CSM) name, product(s), revenue (e.g. ARR), renewal date for the customer, and customer status (e.g. renewed or churned). The customer-health trend may show how customer health for that customer (high, medium, or low) has been trending since the launch of the product. The customer insights may include recommendations that help the user to dive deeper into the account with actionable insights on how to proceed. The customer insights may provide insights about customers that require immediate attention while managing a business's top 10 accounts, along with account details, churn/expansion profiles, and recommendations on next steps. These insights may be the results of analysis using trained AI models that analyze KPIs and best practices for customer success to give the user more accurate and intuitive recommendations to prevent churn and accelerate upsells.

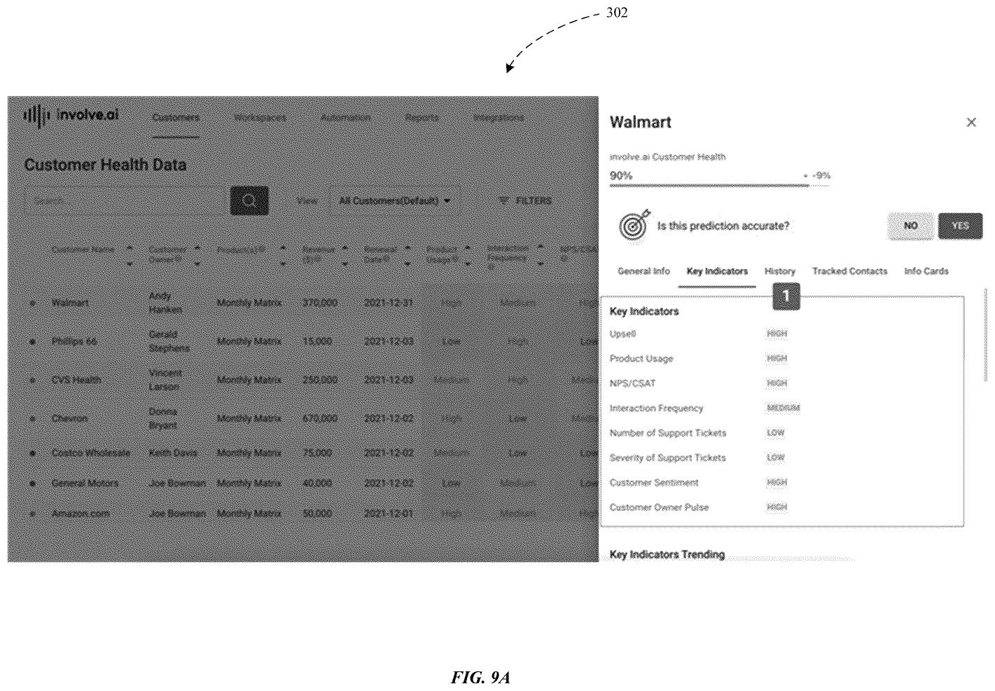

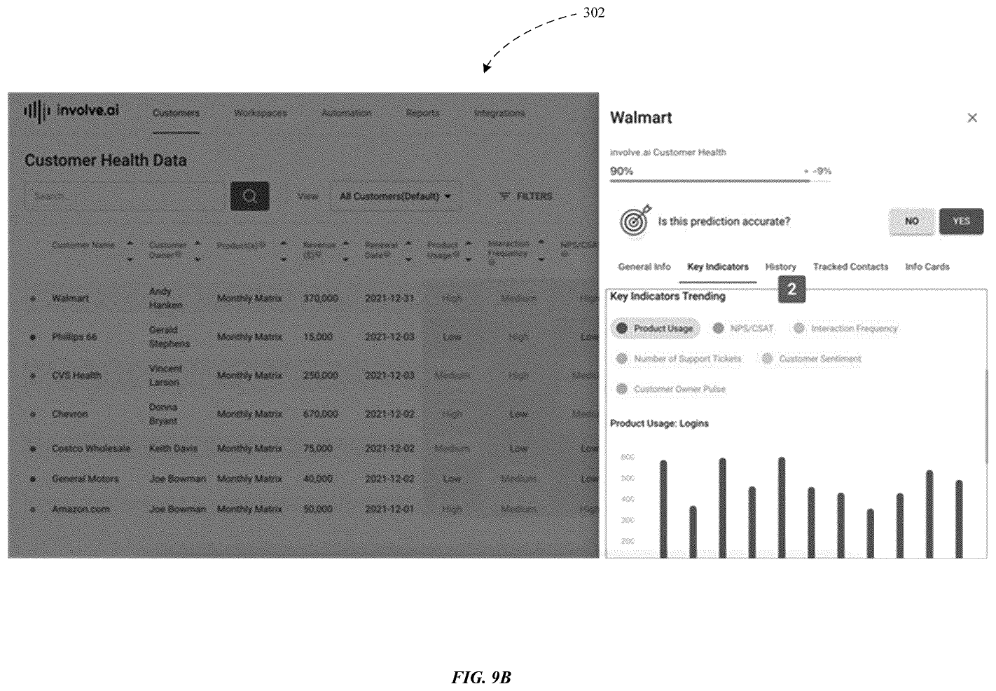

FIGS. 9A-9B illustrates example presentation of example key indicators for an example customer on an example customer-intelligence dashboard 302. In particular embodiments, key indicators provide an extension of high-level customer information, including KPIs measured as high, medium, or low and associated trends with each KPI.

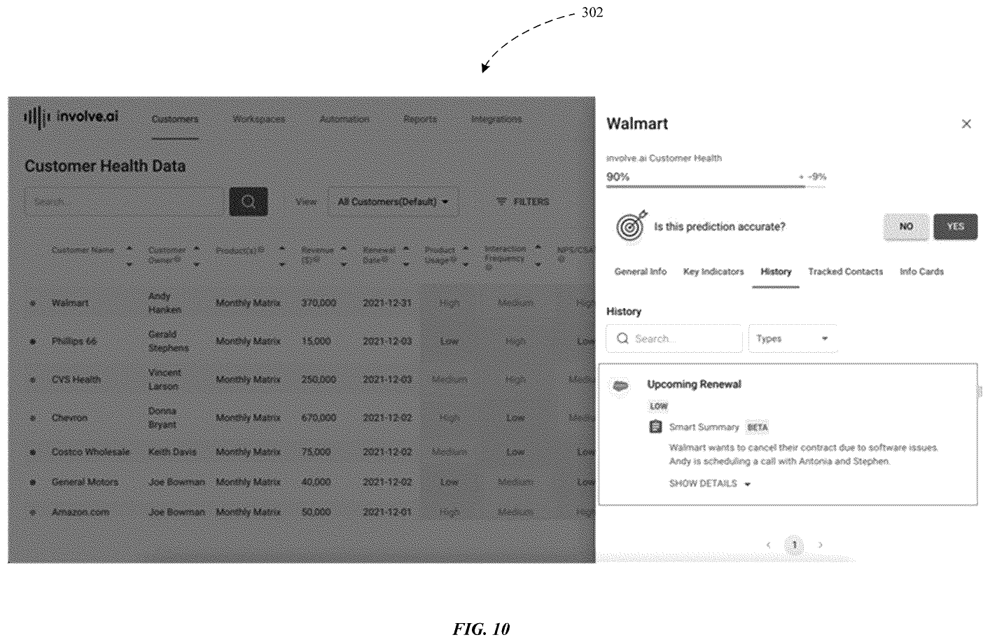

FIG. 10 illustrates example presentation of example customer history for an example customer on an example customer-intelligence dashboard 302. In particular embodiments, a history window provides access to all interaction information associated with the customer. This may include chronological information of updates to the KPIs week over week or month over month, depending on how often the dashboard is refreshed. It may also include e-mail content and e-mail sentiment (e.g. whether the e-mail is positive (high), negative (low), or neutral (medium)). This scoring may be based on sentiment analysis of each e-mail and particular pre-determined keywords. This may help the user access historical data and, using AI, assess that data to determine next steps.

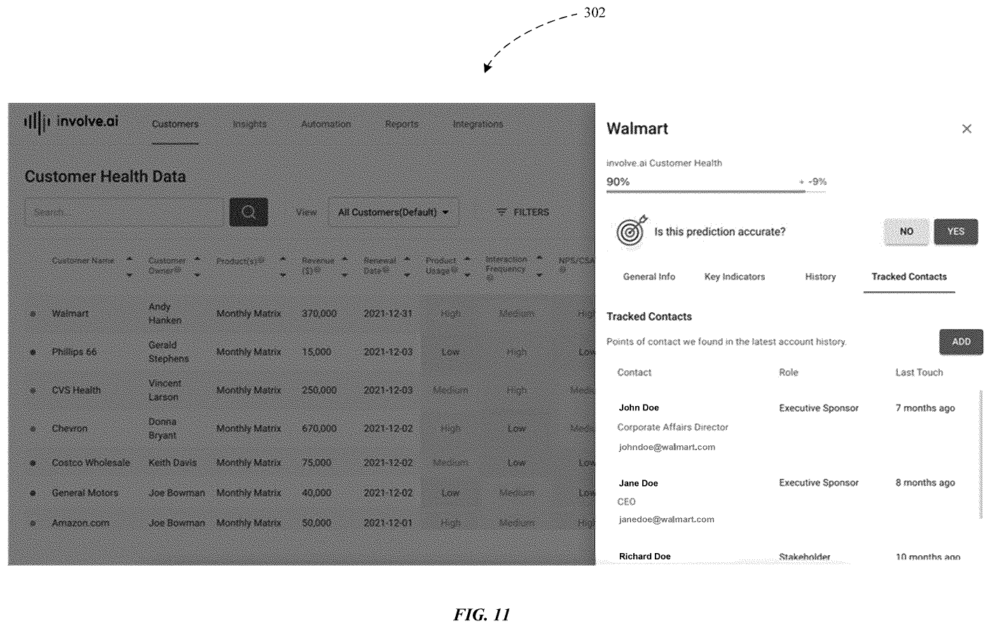

FIG. 11 illustrates example presentation of example tracked contacts for an example customer on an example customer-intelligence dashboard 302. In particular embodiments, a tracked-contacts window enables the user to track all stakeholders associated with the customer. It may also enable the user to add more stakeholder information. This information may be retrieved through AI running on customer interactions.

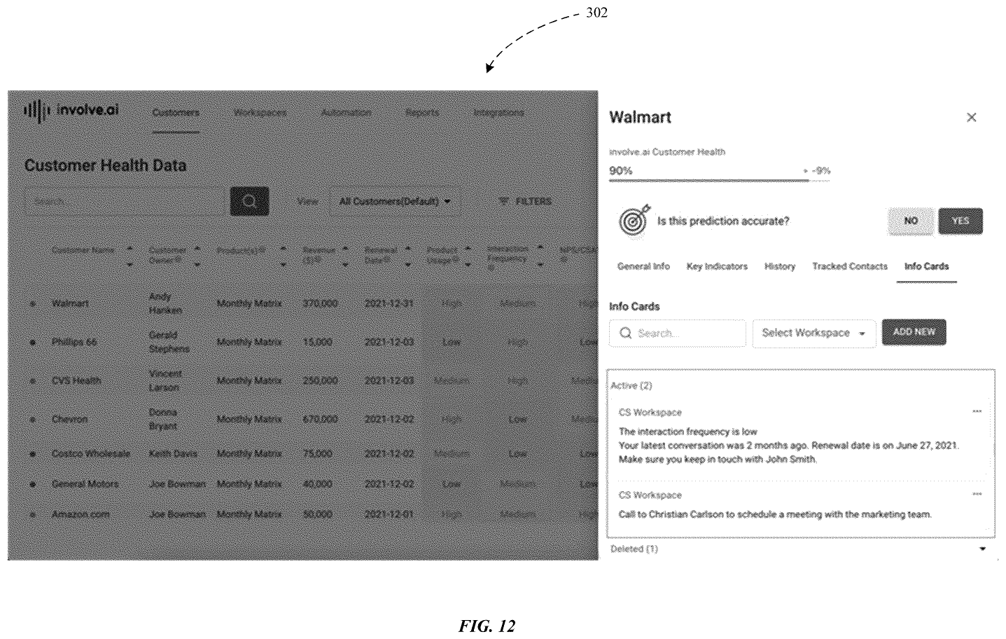

FIG. 12 illustrates example presentation of example information cards on an example customer on an example customer-intelligence dashboard 302. In particular embodiments, the user may create information cards with action items and delegations to colleagues or the user based on the predictions and recommendations provided by customer-intelligence system. This may serve as a single location where the user and the user's colleagues may see unified customer data for one or more customers, along with predictions, recommendations, and action items.

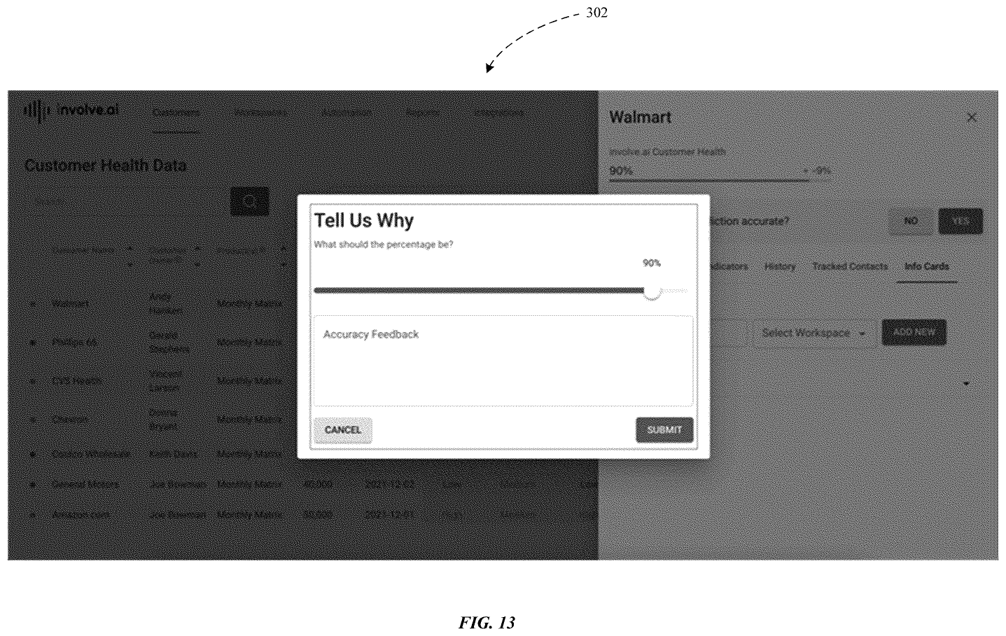

FIG. 13 illustrates an example window for example prediction feedback on an example customer-intelligence dashboard 302. In particular embodiments, customer-intelligence dashboard 302 enables the user to provide feedback and establish a continuous feedback loop if the user wants to add additional context or other information to predictions or recommendations being generated by customer-intelligence system 102, which may enable continual training of the AI of customer-intelligence system 102 based on varying business models.

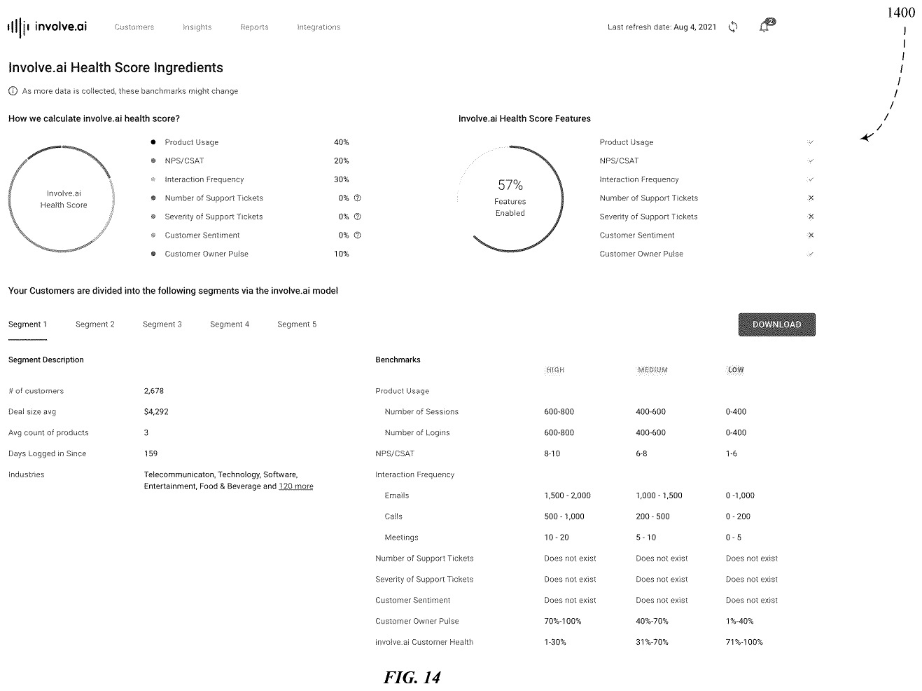

FIG. 14 illustrates example window 1400 presenting KPIs and their contributions to a customer-health score. In the example of FIG. 14, a user may select an icon (not illustrated in FIG. 4) on customer-intelligence dashboard 302 and, in response, be directed to window 1400. In window 1400, a user may select a segment and view a description and breakdown of the segment. In addition, the user may view the benchmarking used with each KPI to determine the scores (high, medium, and low) that are being presented for the KPIs and a breakdown of the data for each KPI.

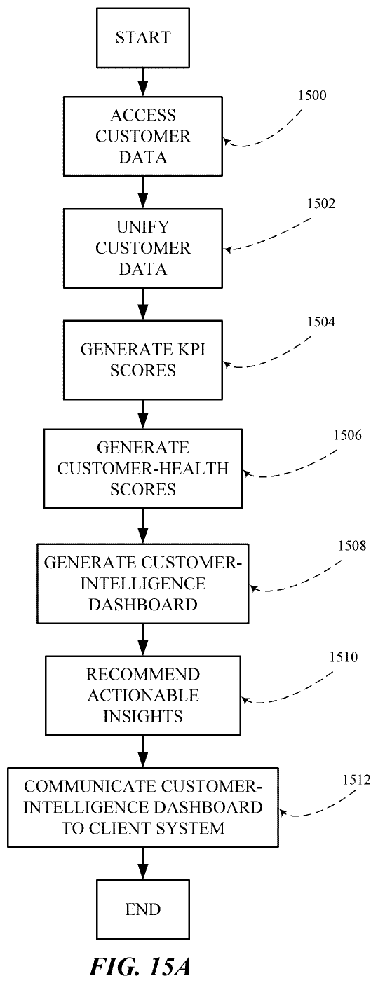

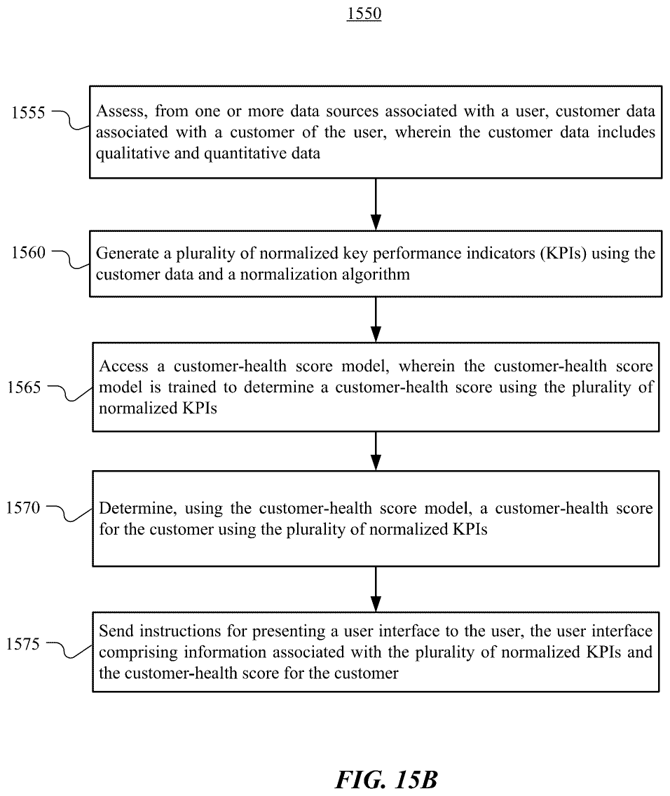

FIG. 15A illustrates an example method for providing a customer-intelligence dashboard. The method may begin at step 1500, where customer-intelligence system 102 accesses customer data of a business entity at data sources 104. As described above, the customer data may include product-usage signals, support signals, and communication signals associated with each of multiple customers and each of one or more products of the business entity. In addition, the customer data may include quantitative data and qualitative data. The method then proceeds to step 1502, where customer-intelligence system 102 unifies the customer data by applying one or more AI models to the customer data. The method then proceeds to step 1504, where, based on the analysis of the customer data, customer-intelligence system 102 generates, for each of the customers and each of the products, a score for each of multiple KPIs for the business entity. As described above, the KPIs may include one or more of the following: product usage; interaction frequency; NPS/CSAT; number of support tickets; severity of support tickets; customer sentiment; customer-owner pulse; up-sells or down-sells; or customer maturity. The method then proceeds to step 1506, where customer-intelligence system 102 generates based on the KPIs a customer-health score for each of the customers and each of the products. As described above, the KPIs may be weighted in the customer-health scores according to SHAP. The method then proceeds to step 1508, where customer-intelligence system 102 generates customer-intelligence dashboard 302 presenting the KPIs and customer-health scores for each of the customers and each of the products. The method then proceeds to step 1510, where customer-intelligence system 102 recommends one or more actionable insights for each of the customers and each of the products based on one or more of the KPI scores or the customer-health scores. The method then proceeds to step 1512, where, in response to a request from a client system 106, customer-intelligence system 102 communicates customer-intelligence dashboard 302 to client system 106 for presentation to a user, at which point the method may end.

Particular embodiments may repeat one or more steps of the method of FIG. 15A, where appropriate. Although this disclosure describes and illustrates particular steps of the method of FIG. 15A as occurring in a particular order, this disclosure contemplates any suitable steps of the method of FIG. 15A occurring in any suitable order. Moreover, although this disclosure describes and illustrates an example method for providing a customer-intelligence dashboard including the particular steps of the method of FIG. 15A, this disclosure contemplates any suitable method for providing a customer-intelligence dashboard including any suitable steps, which may include all, some, or none of the steps of the method of FIG. 15A, where appropriate. Furthermore, although this disclosure describes and illustrates particular components, devices, or systems carrying out particular steps of the method of FIG. 15A, this disclosure contemplates any suitable combination of any suitable components, devices, or systems carrying out any suitable steps of the method of FIG. 15A.

FIG. 15B illustrates an example method 1550 for determining customer-health score. The method may begin at step 1555, where customer-intelligence system 102 accesses, from one or more data sources associated with a user, customer data associated with a customer of the user. As described above, the customer data may include qualitative and quantitative data, such as product-usage signals, support signals, and communication signals associated with each of multiple customers and each of one or more products of the business entity. In addition, the customer data may include quantitative data and qualitative data. The method then proceeds to step 1560, where customer-intelligence system 102 generates a plurality of normalized KPIs using the customer data and a normalization algorithm. As described above, the KPIs may include one or more of the following: product usage; interaction frequency; NPS/CSAT; number of support tickets; severity of support tickets; customer sentiment; customer-owner pulse; up-sells or down-sells; or customer maturity. The method then proceeds to step 1565, where, based on the analysis of the customer data, customer-intelligence system 102 accesses a customer-health score model. The customer-health score model is trained to determine a customer-health score using the plurality of normalized KPIs. The method then proceeds to step 1570, where customer-intelligence system 102 determines, using the customer-health score model, a customer-health score for the customer using the plurality of normalized KPIs. As described above, the KPIs may be weighted in the customer-health scores according to SHAP. The method then proceeds to step 1575, where customer-intelligence system 102 sends instructions for presenting a user interface to the user, the user interface comprising information associated with the plurality of normalized KPIs and the customer-health score for the customer.

Particular embodiments may repeat one or more steps of the method of FIG. 15B, where appropriate. Although this disclosure describes and illustrates particular steps of the method of FIG. 15B as occurring in a particular order, this disclosure contemplates any suitable steps of the method of FIG. 15B occurring in any suitable order. Moreover, although this disclosure describes and illustrates an example method for determining customer-health score including the particular steps of the method of FIG. 15B, this disclosure contemplates any suitable method for determining customer-health score including any suitable steps, which may include all, some, or none of the steps of the method of FIG. 15B, where appropriate. Furthermore, although this disclosure describes and illustrates particular components, devices, or systems carrying out particular steps of the method of FIG. 15B, this disclosure contemplates any suitable combination of any suitable components, devices, or systems carrying out any suitable steps of the method of FIG. 15B.

Particular embodiments provide a customer-health predictive model that recognizes a relative health (e.g. a probability to renew) of a customer relationship based on values or trajectories of KPIs over time. Particular embodiments automatically assign an AI-generated health score to each customer of a business, which may reduce the time and work required to develop customer-success positions and enables quicker and easier identification of customers that are more likely to churn and customers that are more likely to be upsold. Particular embodiments use a health-score model that is trained to recognize a relative health of a customer relationship based on KPIs as inputs, with a substantial historical data set. Such KPIs may include, for example, product-usage metrics, interaction-frequency metrics, net-promoter scores, and others.

Particular embodiments may, by gathering data from different sources as input to an AI model, facilitate a dashboard merging data from different sources, which may provide static and dynamic values for a business's customer relationships. Particular embodiments may dynamically, automatically, and mathematically predict a current relative health of a customer relationship. Particular embodiments provide prioritization of customer accounts based on churn risk or expansion opportunities. Particular embodiments substantially unify indicators that often are sourced from disparate data sources. For example, product-usage data may live in software services such as PENDO while support-ticket data may live in ZENDESK. Other metrics such as customer-owner pulse may exist in SALESFORCE. Particular embodiments provide end users with data-driven understanding of customer health.

Particular embodiments start with integrating a business's customer data (e.g. from data sources 104) with a database (such as customer-intelligence data store 216) associated with customer-intelligence system 102 using extract, transform, load (ETL) tools associated with customer-intelligence system 102. Particular embodiments may also provide an integrations function on a user interface that enables a user associated with the business (through a client system 106) to further integrate other CRM or other customer data of the business with the database associated with customer-intelligence system 102. The database may be a SNOWFLAKE database or any other suitable database. The integrated customer data is then converted into particular views that may be presented to the user, e.g., in customer-intelligence dashboard 302. In particular embodiments, the KPIs for the business's customers (and other metrics associated with them) are the data source for a prediction model. As described above, example KPIs include product usage, interaction frequency, NPS/CSAT, number of support tickets, severity of support tickets, customer sentiment, customer pulse, customer maturity, and up-sell. In particular embodiments, product usage is an aggregate of various product-usage metrics provided by the business and based on the business type. Each product-usage metric may be normalized individually and the mean value of the normalized data may then be normalized to form a product-usage value. Such normalization may be carried out using a min/mean method. Normalization is an important step in particular embodiments because of the heterogeneous nature of user data (e.g., User A and User B could track very different types of customer data). The customer-intelligence system may not necessarily know the meaning, significance, or distribution of each type of data, nor would it have to, once the data is normalized. In particular embodiments, a min-mean method of normalization is found to be particularly useful for normalization. Min-mean normalization may be defined as:

$${x}^{″} = \frac{{x}^{′} - min ( x )}{mean ( x ) - min ( x )}$$

where x represents a collection of data or feature, x′ represents an instance in the collection, and x″ represents a normalized value for x′. For example, if a collection of data has a distribution of values between 18 and 80 (e.g., a customer's age), min(x) would be 18. In this example, we will assume mean(x)=35. Thus, for a given customer whose age x′ is 62, his normalized age would be x″=(62−18)/(35−18)=2.588. While certain embodiments may use min-mean normalization, one of ordinary skill in the art would appreciate that other suitable normalization methods may be used instead.

In particular embodiments, interaction frequency is an aggregate of various interaction-frequency metrics provided by the business. For example, it may include an aggregate of number of telephone calls, number of e-mails, and number of meetings. Each of these metrics may be normalized individually and their mean value may be normalized to form an interaction-frequency value. Such normalization may be carried out using a min/mean method or any other suitable normalization methods. In particular embodiments, values for NPS/CSAT, number of support tickets, customer sentiment may also be normalized using a min/mean method. In particular embodiments, values for severity of support tickets may be normalized using a quantile method or other suitable normalization method. In particular embodiments, values for customer pulse may be normalized using a quantiles method (or any other suitable normalization method), depending on the format of the data.

In particular embodiments, product usage measures actions taken by the client's customers using the product and/or service. The individual product usage metrics will vary between clients as clients have different product/service offerings. For example, the product usage metric can include 1) number of logins which counts the number of time a customer logins to the client's product, 2) number of tasks completed which is count of the number of tasks completed, and 3) reports generated which is count of the number of reports generated by the customer in the client's product. In particular embodiments, interactive frequency measures all interactions between a client and the customer, such as emails between the client and the customer, the client's webinars the customer attends, meetings between the client and the customer, messages or other chat widgets that can be embedded into the client's product between the client and the customer, and calls between the client and the customer. In particular embodiments, NPS/CSAT measures the customer's satisfaction and loyalty for the client. For example, NPS has a value between 1 and 10, 1 being low and 10 being high. As another example, CSAT has a value between 1 and 5, 1 being low and 5 being high. In particular embodiments, number of support tickets measures the number of support tickets a client's customer has opened, which is count of support tickets opened by the customer on service desks. In particular embodiments, severity of support tickets measures how important or impactful the support ticket is. A higher severity support ticket can have a bigger impact on the customer's health score. For example, the severity of support tickets can be assigned a priority code in the range of 1-5 for different priority levels, such as lowest, low, medium, high, and highest. For example, a highest priority level has a priority code of 5. As another example, a lowest priority level has a priority code of 1. In particular embodiments, customer sentiment measures the emotional sentiment from customer interactions with the client, such as support ticket description/body, email bodies sent from the customer, and call/meeting transcripts. In particular embodiments, customer pulse measures a customer success manager's evaluation about the customer, such as likely to expand, likely to renew, watch, at risk, likely to Churn. In particular embodiments, customer maturity is calculated as the number of days since the business began doing business with a customer and the values are then normalized using a min-mean method or other suitable normalization method. The customer maturity measures how long a customer has been a customer of the client's, which is calculated by the difference between a current time and a previous time a customer account associated with the customer was created in the client's customer relationship management (CRM) or a contract signed date of the customer. In particular embodiments, up-sell measures changes in customer revenue overtime which is a value difference between a current contract and a previous contract. For example, a positive value indicates a “high” up-sell (which may be a two as input into the model), a negative value indicates a “low” up-sell (which may be a zero as input into the model), and a zero value indicates a “medium” up-sell (which may be a one as input into the model). As another example, it is an up-sell when a customer renews for a higher amount than the prior period and it is a down-sell when the customer renews for a lower amount than the prior period.

Particular embodiments use a seven-feature model that uses the following features: (1) product usage; (2) interactive frequency; (3) NPS/CSAT; (4) number of support tickets; (5) severity of support tickets; (6) customer sentiment; and (7) customer pulse. From these outputs, a customer-health score can be generated. Particular embodiments use a nine-feature model that uses the following features: (1) product usage; (2) interactive frequency; (3) NPS/CSAT; (4) number of support tickets; (5) severity of support tickets; (6) customer sentiment; (7) customer pulse; (8) customer maturity; and (9) up-sell. From these outputs, a customer-health score can be generated.

Training data for each model may be curated based on experience or expertise of one or more individuals involved in the training of the model. For example, it may be curated by populating all possible permutations of the normalized feature space and an associated ground-truth value. The following is an example row of training data for a seven-feature model: 0, 1, 2, 0, 0, 1, 40. The following is an example row of training data for a nine-feature model: 1, 1, 2, 0, 2, 0, 1, 1, 50. In particular embodiments, the feature value of a particular feature in the training data may be a normalized data value of an original raw data value (e.g., normalized using the min-mean normalization technique). In other embodiments, the feature value of a particular feature in the training data may be a feature score (e.g., within a score range of 0-2) derived from a normalized data value of an original raw data value. In particular embodiments, training data for seven- or nine-feature models may be maintained by modifying target values or adding or removing rows. In addition, particular embodiments may add other inputs to the training data. Each training data in the training data set may have an associated ground-truth label. The ground-truth label, for example, may be a final customer-health score (e.g., a value between 0 and 100) annotated or assigned by someone with domain knowledge or experience. Particular embodiments may train a machine-learning model based on the training data set so that, once the model is trained, it can be used to process the features values of a given customer and predict a corresponding customer-health score. In particular embodiments, different ranges of customer-health score may be mapped to different discrete conclusions about the customer, such as Likely to Renew, Likely to Churn, etc. In particular embodiments, the customer-health score may be used to provide different insights or suggestions to the user of the customer-intelligence system. For example, a low customer-health score below a predetermined threshold (e.g., 20) may trigger a recommendation engine. The recommendation engine may have one or more pattern recognition logic and identify problem areas. For example, if the interaction frequency with that customer is particularly low, the recommendation engine may provide a recommendation to email or call the customer more often.

In particular embodiments, after the input data is normalized and ready for prediction, null values in the input data are filled with a numerical value, ranging from zero to two. The numerical values used for imputation may vary from column to column, and the optimal value may be found for each column that elevates the accuracy as much as possible. The optimal value for each column may be found by filling the null values with one of 15 random continuous values between zero and two. With 15 possible values for each column, the total combination count ranges to be in the millions, but the loop may be run on 50,000 combinations of imputation values. A best combination of them based on accuracy may be used as an optimal value. After each column's null values are imputed, it may be input into a pre-trained seven-feature or nine-feature model, based on whether customer maturity or up-sell are present. In particular embodiments, both models are linear models trained using SKLearn's linear-regression function. The value output by the model is a health score for each row inputted.

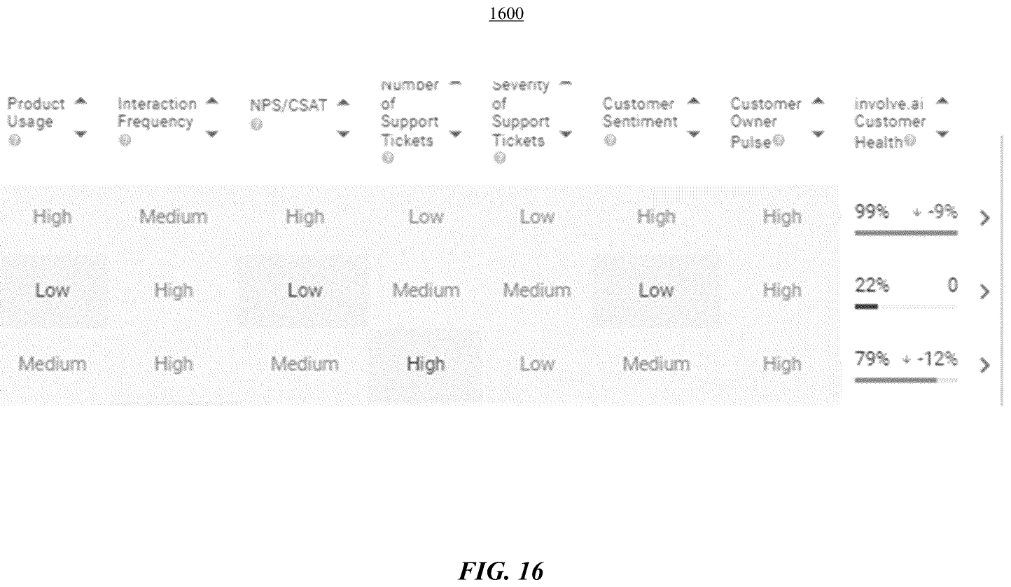

FIG. 16 illustrates example window 1600 simple view of high, medium, and low scores presented for the KPIs and health scores using a seven-feature model. FIG. 16 shows a breakdown of the data for each KPI to each customer of a business using normalized KPIs and a seven-feature model which include 1) product usage; (2) interactive frequency; (3) NPS/CSAT; (4) number of support tickets; (5) severity of support tickets; (6) customer sentiment; and (7) customer pulse. As a result, customer-intelligence system 102 can determine a customer-health score to each customer of a business by using the health scores (high, medium, and low) that are being presented for the KPIs and a breakdown of the data for each KPI.

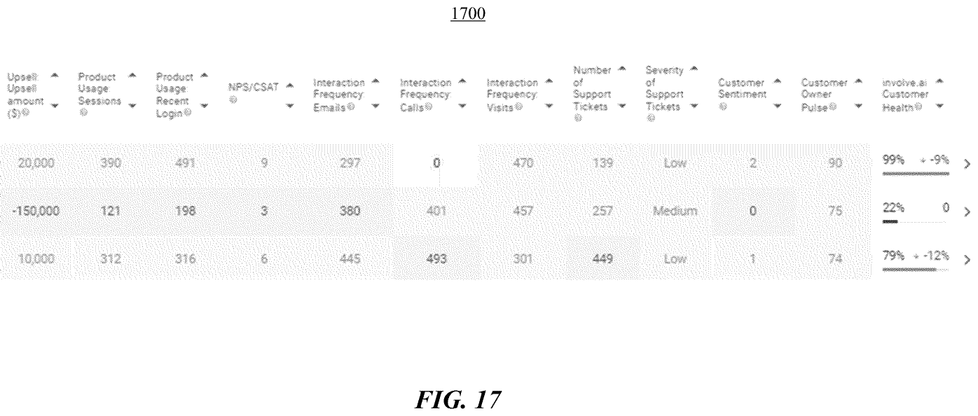

FIG. 17 illustrates example window 1700 simple view of normalized KPIs and health scores using a nine-feature model. FIG. 17 shows a breakdown of the data to each customer of a business for each KPI using normalized KPIs and a nine-feature model which include 1) product usage; (2) interactive frequency; (3) NPS/CSAT; (4) number of support tickets; (5) severity of support tickets; (6) customer sentiment; (7) customer pulse; (8) customer maturity; and (9) up-sell. As a result, customer-intelligence system 102 can determine a customer-health score to each customer of a business by using normalized KPIs and a breakdown of the data for each KPI.

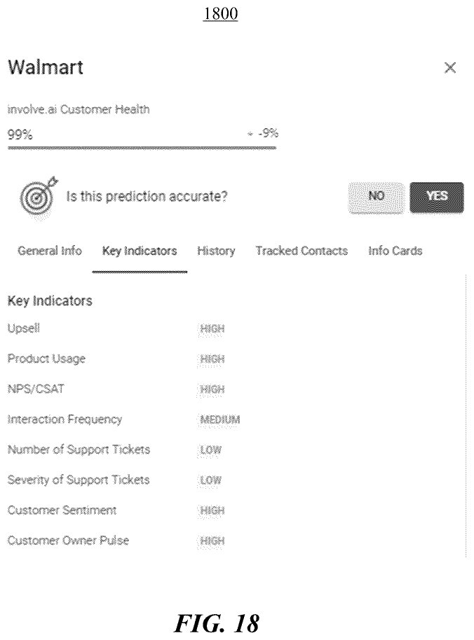

FIG. 18 illustrates example window 1800 simple view of key indicators normalized with respect to a customer. In the example of FIG. 18, a user may select an icon (not illustrated in FIG. 4) on customer-intelligence dashboard 302 and, in response, be directed to window 1800. In window 1800, a user may select the customer and view a customer-health score, a description and breakdown of the key indicators for the customer. In addition, the user may view the key indicators normalized with respect to the customer which are shown as the scores (high, medium, and low) presented for the KPIs and a breakdown of the data for each KPI.

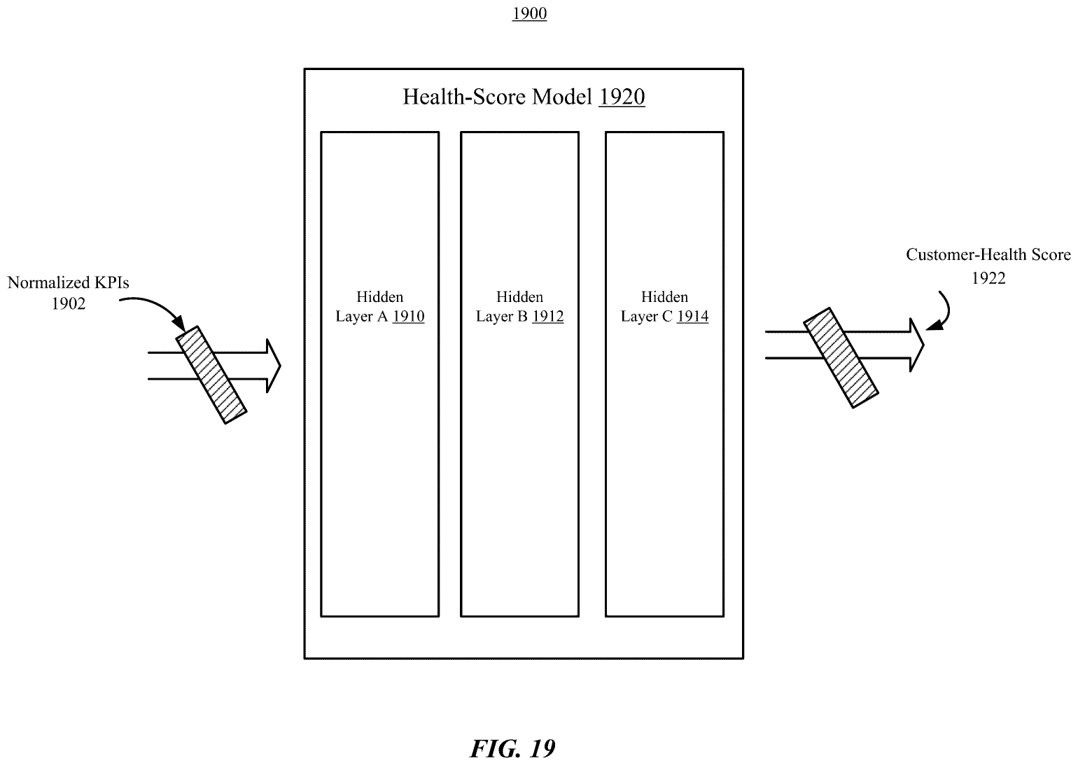

FIG. 19 illustrates example neural network 1900 for determining a customer-health score 1922 using normalized KPIs 1920. In particular embodiments, health-score module 206 can include a health-score model 1920 which is trained with substantial historical data and computational power. In particular embodiments, the health-score model is trained to recognize the relative health of a customer relationship based on trajectories of particular KPIs over time, such as a polynomial relationship. To train an AI model, particular embodiments input a dataset and indicate to the AI model the expected output for the dataset. The data set is then reviewed and a function is generated to show how the AI's models predicted outputs were wrong relative to actual output. The weights of the neurons are changed until the function reaches an optimal minimum. To minimize the function, particular embodiments iterate through the dataset multiple times until the AI model understands patters consistent with a churned customer versus expansion (e.g. parameters causing the customer to churn versus parameters that indicate that the customer relationship will expand).

In particular embodiments, the health-score model 1920 is trained using a neural network, such as decision tree, support vector machine, and gradient boosting neural network, etc., for determining the customer-health score 1922 based on normalized KPIs 1920. The health-score model 1920 can include a plurality of hidden layers, such as hidden layer A 1910, hidden layer B 1912, and hidden layer C 1914, which may be a convolutional layer, a pooling layer, a rectified linear unit (ReLU) layer, a softmax layer, a regressor layer, a dropout layer, and/or various other hidden layer types. These hidden layers can be arranged in any order as long as they satisfy the input/output size criteria. Each layer comprises of a set number of image filters. The output of filters from each layer is stacked together in the third dimension. This filter response stack then serves as the input to the next layer(s). In an embodiment, each hidden layer is a combination of a convolutional layer, a pooling layer, and a ReLU layer in a multilayer architecture. For example, each hidden layer, such as hidden layer A 1910, hidden layer B 1912, and hidden layer C 1914, has a convolutional layer, a pooling layer, and a ReLU layer. The hidden layer A 1910 may be down-sampling blocks to extract high-level features from the input data set. The hidden layer C 1914 may be up-sampling blocks to output the classified or predicted output data set. The hidden layer B 1912 may perform residual stacking as bottleneck between down-sampling blocks, such as hidden layer A 1910, and up-sampling blocks, such as hidden layer C 1914. The hidden layer C 1914 may include a softmax layer or a regressor layer to classify or predict a predetermined class or a value based on input attributes.

Furthermore, in a convolutional layer, the input data set is convolved with a set of learned filters, designed to highlight specific characteristics of the input data set. A pooling layer produces a scaled down version of the output. This is achieved by considering small neighborhood regions and applying the desired operation filter (e.g. min, max, mean, etc.) across the neighborhood. A ReLU layer enhances the nonlinear property of the network by introducing a non-saturating activation function. One example of such a function is to threshold out negative responses (set negative values to zero). A fully connected layer provides a high-level reasoning by connecting each node in the layer to all activation nodes in the previous layer. A softmax layer maps the inputs from the previous layer into a value between 0 and 1 which allows for interpreting the outputs as probabilities and selection of classified facie with highest probability. A dropout layer offers a regularization technique for reducing network over-fitting on the training data by dropping out individual nodes with a certain probability. A loss layer (utilized in training) defines the weight dependent cost function that needs to be optimized (bring cost down to zero) for improved accuracy.

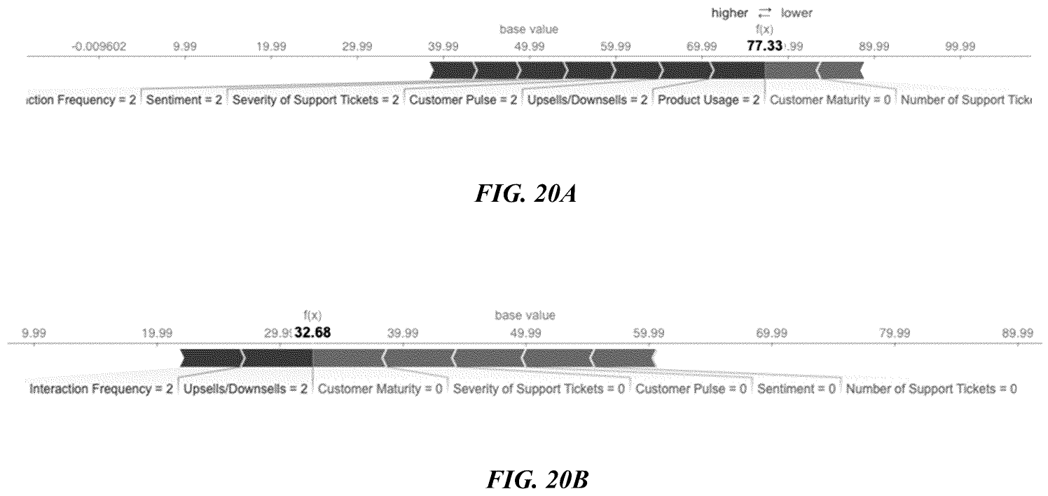

FIGS. 20A and 20B illustrate example inference or prediction processes with high and low customer-health scores. FIG. 20A shows a high customer-health score associated with a first new customer. The first new customer has a low score for customer maturity and number of support tickets, and the new customer has a high score for other KPIs. As a result, this combination of metrics is representative of an expansion profile associated with the first new customer. FIG. 20B shows a low customer-health score associated with a second new customer. The second new customer has a high score for interaction frequency. Many of those interactions have a low renewal sentiment because the AI model identifies that the majority of a customer's metrics point toward churn despite interaction frequency and up-sell being high. Therefore, a possible further inference is that the second new customer is with additional features to a product or service.

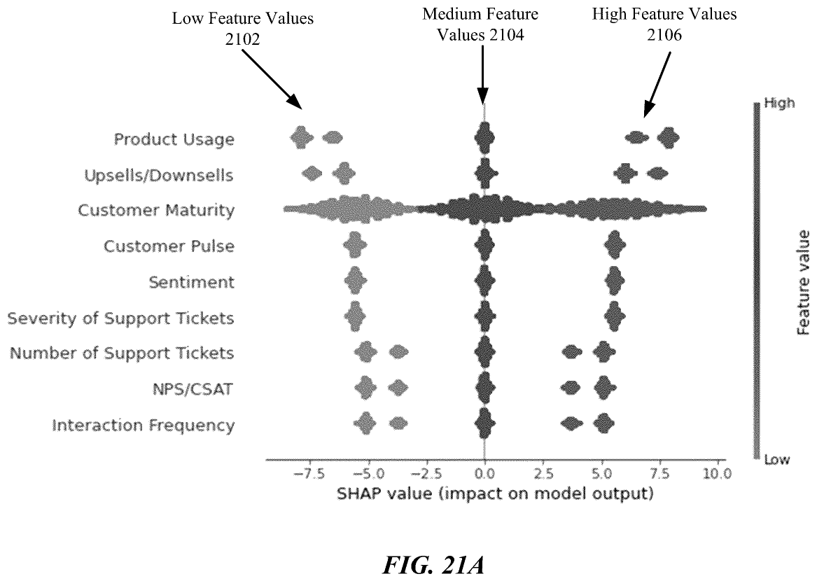

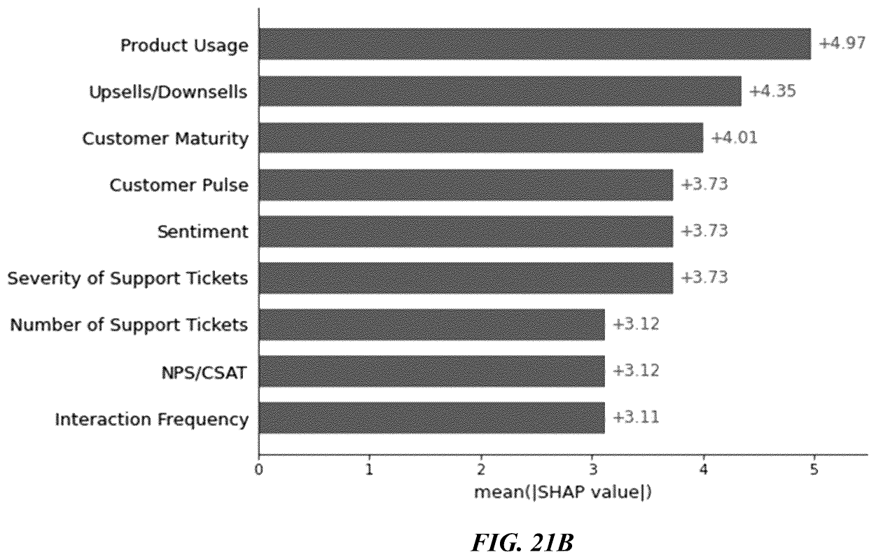

FIGS. 21A and 21B illustrate example impact of SHAP analysis on the output of the AI model. FIG. 21A shows the SHAP value for low feature values 2102, medium feature values 2104, and high feature values 2106 based on a nine-feature model. It is clear that different KPI features have different impacts on the model output. For example, high feature values 2106 have positive impact on the model output for all the model features. As another example, low feature values 2102 have negative impact on the model output for all the model features. FIG. 21B shows the mean SHAP value as weightages for the nine features for high feature values 2106 in the nine-feature model: 1) a weight of “4.97” for product usage; (2) a weight of “3.11” for interactive frequency; (3) a weight of “3.12” for NPS/CSAT; (4) a weight of “3.12” for number of support tickets; (5) a weight of “3.73” for severity of support tickets; (6) a weight of “3.73” for customer sentiment; (7) a weight of “3.73” for customer pulse; (8) a weight of “4.01” for customer maturity; and (9) a weight of “4.35” for up-sell. In particular embodiments, a user may view the calculated customer-health scores through a web-based application with color-coded table cells indicating the predictors.

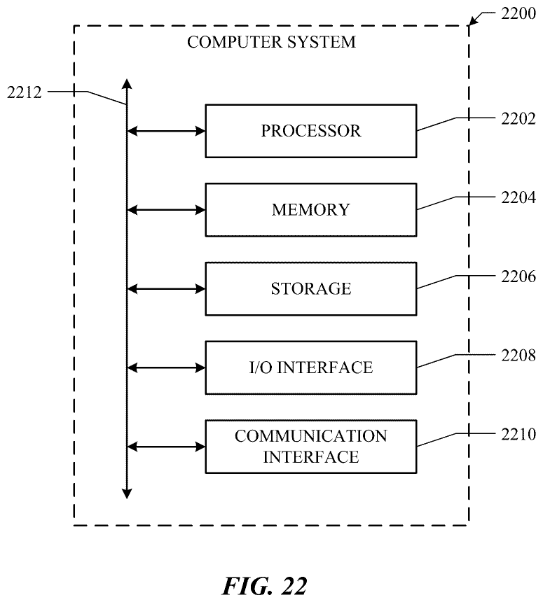

FIG. 22 illustrates an example computer system 2200. In particular embodiments, one or more computer systems 2200 perform one or more steps of one or more methods described or illustrated herein. In particular embodiments, one or more computer systems 2200 provide functionality described or illustrated herein. In particular embodiments, software running on one or more computer systems 2200 performs one or more steps of one or more methods described or illustrated herein or provides functionality described or illustrated herein. Particular embodiments include one or more portions of one or more computer systems 2200. Herein, reference to a computer system may encompass a computing device, and vice versa, where appropriate. Moreover, reference to a computer system may encompass one or more computer systems, where appropriate.

This disclosure contemplates any suitable number of computer systems 2200. This disclosure contemplates computer system 2200 taking any suitable physical form. As example and not by way of limitation, computer system 2200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 2200 may include one or more computer systems 2200; be unitary or distributed; span multiple locations; span multiple machines; span multiple data centers; or reside in a cloud, which may include one or more cloud components in one or more networks. Where appropriate, one or more computer systems 2200 may perform without substantial spatial or temporal limitation one or more steps of one or more methods described or illustrated herein. As an example and not by way of limitation, one or more computer systems 2200 may perform in real time or in batch mode one or more steps of one or more methods described or illustrated herein. One or more computer systems 2200 may perform at different times or at different locations one or more steps of one or more methods described or illustrated herein, where appropriate.

In particular embodiments, computer system 2200 includes a processor 2202, memory 2204, storage 2206, an input/output (I/O) interface 2208, a communication interface 2210, and a bus 2212. Although this disclosure describes and illustrates a particular computer system having a particular number of particular components in a particular arrangement, this disclosure contemplates any suitable computer system having any suitable number of any suitable components in any suitable arrangement.

In particular embodiments, processor 2202 includes hardware for executing instructions, such as those making up a computer program. As an example and not by way of limitation, to execute instructions, processor 2202 may retrieve (or fetch) the instructions from an internal register, an internal cache, memory 2204, or storage 2206; decode and execute them; and then write one or more results to an internal register, an internal cache, memory 2204, or storage 2206. In particular embodiments, processor 2202 may include one or more internal caches for data, instructions, or addresses. This disclosure contemplates processor 2202 including any suitable number of any suitable internal caches, where appropriate. As an example and not by way of limitation, processor 2202 may include one or more instruction caches, one or more data caches, and one or more translation lookaside buffers (TLBs). Instructions in the instruction caches may be copies of instructions in memory 2204 or storage 2206, and the instruction caches may speed up retrieval of those instructions by processor 2202. Data in the data caches may be copies of data in memory 2204 or storage 2206 for instructions executing at processor 2202 to operate on; the results of previous instructions executed at processor 2202 for access by subsequent instructions executing at processor 2202 or for writing to memory 2204 or storage 2206; or other suitable data. The data caches may speed up read or write operations by processor 2202. The TLBs may speed up virtual-address translation for processor 2202. In particular embodiments, processor 2202 may include one or more internal registers for data, instructions, or addresses. This disclosure contemplates processor 2202 including any suitable number of any suitable internal registers, where appropriate. Where appropriate, processor 2202 may include one or more ALUs; be a multi-core processor; or include one or more processors 2202. Although this disclosure describes and illustrates a particular processor, this disclosure contemplates any suitable processor.

In particular embodiments, memory 2204 includes main memory for storing instructions for processor 2202 to execute or data for processor 2202 to operate on. As an example and not by way of limitation, computer system 2200 may load instructions from storage 2206 or another source (such as, for example, another computer system 2200) to memory 2204. Processor 2202 may then load the instructions from memory 2204 to an internal register or internal cache. To execute the instructions, processor 2202 may retrieve the instructions from the internal register or internal cache and decode them. During or after execution of the instructions, processor 2202 may write one or more results (which may be intermediate or final results) to the internal register or internal cache. Processor 2202 may then write one or more of those results to memory 2204. In particular embodiments, processor 2202 executes only instructions in one or more internal registers or internal caches or in memory 2204 (as opposed to storage 2206 or elsewhere) and operates only on data in one or more internal registers or internal caches or in memory 2204 (as opposed to storage 2206 or elsewhere). One or more memory buses (which may each include an address bus and a data bus) may couple processor 2202 to memory 2204. Bus 2212 may include one or more memory buses, as described below. In particular embodiments, one or more memory management units (MMUs) reside between processor 2202 and memory 2204 and facilitate accesses to memory 2204 requested by processor 2202. In particular embodiments, memory 2204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 2204 may include one or more memories 2204, where appropriate. Although this disclosure describes and illustrates particular memory, this disclosure contemplates any suitable memory.

In particular embodiments, storage 2206 includes mass storage for data or instructions. As an example and not by way of limitation, storage 2206 may include a hard disk drive (HDD), a floppy disk drive, flash memory, an optical disc, a magneto-optical disc, magnetic tape, or a Universal Serial Bus (USB) drive or a combination of two or more of these. Storage 2206 may include removable or non-removable (or fixed) media, where appropriate. Storage 2206 may be internal or external to computer system 2200, where appropriate. In particular embodiments, storage 2206 is non-volatile, solid-state memory. In particular embodiments, storage 2206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 2206 taking any suitable physical form. Storage 2206 may include one or more storage control units facilitating communication between processor 2202 and storage 2206, where appropriate. Where appropriate, storage 2206 may include one or more storages 2206. Although this disclosure describes and illustrates particular storage, this disclosure contemplates any suitable storage.

In particular embodiments, I/O interface 2208 includes hardware, software, or both, providing one or more interfaces for communication between computer system 2200 and one or more I/O devices. Computer system 2200 may include one or more of these I/O devices, where appropriate. One or more of these I/O devices may enable communication between a person and computer system 2200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 2208 for them. Where appropriate, I/O interface 2208 may include one or more device or software drivers enabling processor 2202 to drive one or more of these I/O devices. I/O interface 2208 may include one or more I/O interfaces 2208, where appropriate. Although this disclosure describes and illustrates a particular I/O interface, this disclosure contemplates any suitable I/O interface.

In particular embodiments, communication interface 2210 includes hardware, software, or both providing one or more interfaces for communication (such as, for example, packet-based communication) between computer system 2200 and one or more other computer systems 2200 or one or more networks. As an example and not by way of limitation, communication interface 2210 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 2210 for it. As an example and not by way of limitation, computer system 2200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 2200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 2200 may include any suitable communication interface 2210 for any of these networks, where appropriate. Communication interface 2210 may include one or more communication interfaces 2210, where appropriate. Although this disclosure describes and illustrates a particular communication interface, this disclosure contemplates any suitable communication interface.

In particular embodiments, bus 2212 includes hardware, software, or both coupling components of computer system 2200 to each other. As an example and not by way of limitation, bus 2212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 2212 may include one or more buses 2212, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. The embodiments disclosed herein are only examples, and the scope of this disclosure is not limited to them. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Particular embodiments may include all, some, or none of the components, elements, features, functions, operations, or steps of the embodiments disclosed herein. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
accessing, from one or more data sources associated with a user, customer data associated with a customer of the user, wherein the customer data includes qualitative and quantitative data;
generating a plurality of normalized key performance indicators (KPIs) using the customer data and a normalization algorithm;
accessing a customer-health score model, wherein the customer-health score model is trained to determine a customer-health score using the plurality of normalized KPIs;
determining, using the customer-health score model, a customer-health score for the customer using the plurality of normalized KPIs; and
sending instructions for presenting a user interface to the user, the user interface comprising information associated with the plurality of normalized KPIs and the customer-health score for the customer.

2. The method of claim 1, further comprising:
applying a K-means clustering algorithm to segment the customer data into component parts associated with the plurality of normalized KPIs by analyzing similarities among a feature space, wherein the optimal number of clusters is determined using an elbow method; and
generating benchmarks for the plurality of normalized KPIs by evaluating the minimum and the maximum value for each category present in the plurality of normalized KPIs, wherein each KPI of the plurality of normalized KPIs has high, medium, and high categories.

3. The method of claim 2, further comprising:
determining a respective threshold value of customer health for each of the normalized KPIs for the customer which is benchmarked across multiple businesses per product per annual recurring revenue (ARR) range per quarter, wherein the threshold value of customer health comprises a high health score, a medium health score, and a low health score.

4. The method of claim 1, further comprising:
determining prioritization of the customer's account based on churn risk or expansion opportunities using the customer-health score for the customer.

5. The method of claim 1, further comprising:
training the customer health score model based on a seven-feature model using the plurality of plurality of KPIs which comprise product usage, interaction frequency, net promoter score (NPS)/customer satisfaction (CSAT), number of support tickets, severity of support tickets, customer sentiment, and customer pulse.

6. The method of claim 1, further comprising:
training the customer health score model based on a nine-feature model using the plurality of plurality of KPIs which comprise product usage, interaction frequency, NPS/CSAT, number of support tickets, severity of support tickets, customer sentiment, customer pulse, customer maturity, and upsell.

7. The method of claim 1, further comprising:
determining normalized values for product usage, interaction frequency, NPS/CSAT, number of support tickets, customer sentiment, and customer maturity by applying the normalization algorithm based on a min/mean method;
determining the normalized values for severity of support tickets and customer pulse by applying the normalization algorithm based on a min/mean method; and
determining the normalized values for upsell based on positive, negative and zero values.

8. The method of claim 1, further comprising:
determining percentages for the plurality of normalized KPIs by applying SHapley Additive exPlanations (SHAP) to represent feature weightages.

9. The method of claim 1, further comprising:
generating high-level reporting data summarizing customer revenue and churns and upsells along with trends around the plurality of normalized KPIs using the customer-health score for the customer.

10. The method of claim 1, further comprising:
dynamically determining a change which measures a relative customer-health score for the customer since a last customer-health score; and
determining a likelihood of churn, renew, or upsell for the customer based on a current customer-health score and the change since the last customer-health score.

11. A system comprising:
one or more processors; and
one or more computer-readable non-transitory storage media coupled to one or more of the processors and comprising instructions operable when executed by one or more of the processors to cause the system to:
access, from one or more data sources associated with a user, customer data associated with a customer of the user, wherein the customer data includes qualitative and quantitative data;
generate a plurality of normalized key performance indicators (KPIs) using the customer data and a normalization algorithm;
access a customer-health score model, wherein the customer-health score model is trained to determine a customer-health score using the plurality of normalized KPIs;
determine, using the customer-health score model, a customer-health score for the customer using the plurality of normalized KPIs; and
send instructions for presenting a user interface to the user, the user interface comprising information associated with the plurality of normalized KPIs and the customer-health score for the customer.

12. The system of claim 11, wherein the instructions are further operable when executed by the one or more of the processors to cause the system to:
applying a K-means clustering algorithm to segment the customer data into component parts associated with the plurality of normalized KPIs by analyzing similarities among a feature space, wherein the optimal number of clusters is determined using an elbow method; and
generate benchmarks for the plurality of normalized KPIs by evaluating the minimum and the maximum value for each category present in the plurality of normalized KPIs, wherein each KPI of the plurality of normalized KPIs has high, medium, and high categories.

13. The system of claim 12, wherein the instructions are further operable when executed by the one or more of the processors to cause the system to:
determine a respective threshold value of customer health for each of the normalized KPIs for the customer which is benchmarked across multiple businesses per product per annual recurring revenue (ARR) range per quarter, wherein the threshold value of customer health comprises a high health score, a medium health score, and a low health score.

14. The system of claim 11, wherein the instructions are further operable when executed by the one or more of the processors to cause the system to:
determine prioritization of the customer's account based on churn risk or expansion opportunities using the customer-health score for the customer.

15. The system of claim 11, wherein the instructions are further operable when executed by the one or more of the processors to cause the system to:
train the customer health score model based on a seven-feature model using the plurality of plurality of KPIs which comprise product usage, interaction frequency, net promoter score (NPS)/customer satisfaction (CSAT), number of support tickets, severity of support tickets, customer sentiment, and customer pulse.

16. The system of claim 11, wherein the instructions are further operable when executed by the one or more of the processors to cause the system to:
train the customer health score model based on a nine-feature model using the plurality of plurality of KPIs which comprise product usage, interaction frequency, NPS/CSAT, number of support tickets, severity of support tickets, customer sentiment, customer pulse, customer maturity, and upsell.

17. The system of claim 11, wherein the instructions are further operable when executed by the one or more of the processors to cause the system to:
determine normalized values for product usage, interaction frequency, NPS/CSAT, number of support tickets, customer sentiment, and customer maturity by applying the normalization algorithm based on a min/mean method;
determine the normalized values for severity of support tickets and customer pulse by applying the normalization algorithm based on a min/mean method; and
determine the normalized values for upsell based on positive, negative and zero values.

18. The system of claim 11, wherein the instructions are further operable when executed by the one or more of the processors to cause the system to:
determine percentages for the plurality of normalized KPIs by applying SHapley Additive exPlanations (SHAP) to represent feature weightages.

19. The system of claim 11, wherein the instructions are further operable when executed by the one or more of the processors to cause the system to:
generating high-level reporting data summarizing customer revenue and churns and upsells along with trends around the plurality of normalized KPIs using the customer-health score for the customer;
dynamically determining a change which measures a relative customer-health score for the customer since a last customer-health score; and
determining a likelihood of churn, renew, or upsell for the customer based on a current customer-health score and the change since the last customer-health score.

20. One or more computer-readable non-transitory storage media embodying software
that is operable when executed to:
access, from one or more data sources associated with a user, customer data associated with a customer of the user, wherein the customer data includes qualitative and quantitative data;
generate a plurality of normalized key performance indicators (KPIs) using the customer data and a normalization algorithm;
access a customer-health score model, wherein the customer-health score model is trained to determine a customer-health score using the plurality of normalized KPIs;
determine, using the customer-health score model, a customer-health score for the customer using the plurality of normalized KPIs; and
send instructions for presenting a user interface to the user, the user interface comprising information associated with the plurality of normalized KPIs and the customer-health score for the customer.
